(19) United States
(12) Patent Application Publication
(10) Pub. No.: US 2025/0097344 A1
(43) Pub. Date: Mar. 20, 2025

(54) CONTEXT-AWARE TELEPHONY SERVICES USING A LOCATION-BASED RULES BUILDER

(71) Applicant: Radar Labs, Inc., New York, NY (US)

(72) Inventors: Nicholas Patrick, Jersey City, NJ (US); Timothy Julien, Brooklyn, NY (US)

(21) Appl. No.: 18/478,330

(22) Filed: Sep. 29, 2023

Related U.S. Application Data
(60) Provisional application No. 63/584,059, filed on Sep. 20, 2023.

(51) Int. Cl. H04M 3/42

(52) U.S. Cl. CPC H04M 3/42348; H04M 2242/30

(57) ABSTRACT

A telephone device includes a location determining module configured to generate location information related to a position of the mobile telephone. The mobile telephone sends the location information to a server and receives from the server instructions to perform at least one action based on the location information sent to the server. The embodiments further describe methods and systems for creating and managing logic in a location infrastructure application. The location infrastructure application can store the rules for each client and automatically implement a given rule when the trigger event selected by the client is detected. Implementation of a rule can involve the execution of one or more actions at a user device for which geolocation data is being collected on behalf of the client's software application. The client can continue to develop and customize their rules as needed using the provided user interface.

### CROSS-REFERENCE TO RELATED APPLICATION

This application claims the benefit of U.S. Provisional Patent Application No. 63/584,059, filed Sep. 20, 2023, and titled “Context-Aware Telephony Services Using a Location-Based Rules Builder,” which is incorporated by reference herein in its entirety.

### TECHNICAL FIELD

The present disclosure generally relates to a mobile telephone device implementing actions for rules generated using a rule builder system for a location infrastructure platform, and specifically to a rules engine that enables users to build customized rules based on dynamic location data that are implemented with telephonic devices.

### BACKGROUND

Geofencing is a location-based service in which an app or other software uses GPS, RFID, Wi-Fi or cellular data to trigger a pre-programmed action when a mobile device or RFID tag enters or exits a virtual boundary set up around a geographical location, known as a geofence. Depending on how a geofence is configured it can prompt mobile push notifications, trigger text messages or alerts, send targeted advertisements on social media, allow tracking on vehicle fleets, disable certain technology or deliver location-based marketing data.

Companies and marketers have been increasingly employing geofencing technology, allowing them to send location-relevant content to mobile users within a geofenced area, or learn about their offline behavior from location data for purposes of audience segmentation, personalization, retargeting, competitive intelligence and online-to-offline attribution. Businesses can use geofencing for safety, time tracking, vehicle tracking and more, or it can be used in home automation, child location services and even law enforcement. With the popularity of mobile devices, once a geographic area has been defined, there may be myriad options for what responses can be triggered.

However, in order to implement such a location-responsive framework, companies are dependent on the software and programming expertise of developers who can integrate the new code into their existing mobile applications, as a geofence will typically be defined within the code of a mobile app. Thus, to enable such technology, an app developer must set up the desired virtual boundary. This virtual boundary can then be used to trigger pre-programmed actions (such as mobile alerts, in-app content, or data insights) as specified by the developer, for customers who have downloaded the relevant retailer or affiliate mobile app. While there are mechanisms by which end-users can create, manage and optimize their geofences, there is no solution that allows layperson end-users to actively create and manage custom rules defining how these geofences trigger specific actions in the context of their mobile application without having to submit a request to a developer and then wait for one or more new rules to be provided in future releases of the customer technical support system.

There is a need in the art for a system and method that addresses the shortcomings discussed above.

### SUMMARY

In one aspect, a mobile telephone including a location infrastructure application configured to provide location information to a server, and receive responses from the server is disclosed. The mobile telephone includes a location determining module configured to generate location information related to a position of the mobile telephone. In addition, the mobile telephone sends the location information to a server, and the mobile telephone receives from the server instructions to perform at least one action based on the location information sent to the server. Furthermore, creation of the instructions includes: (1) receiving, at a server for the location infrastructure application and from a client via a rules builder interface, a first user context selection to serve as a trigger for a first rule, the first user context selection specifying a first user context that includes detection of a first event occurring in or near a first pre-defined geographic area; (2) receiving, at the server and from the client via the rules builder interface, a response selection for the first rule, the response selection including at least a first action to be implemented by the location infrastructure application upon detection that all conditions specified by the first user context selection are satisfied; (3) receiving, at the server and from the mobile telephone, first location data for the mobile telephone over a first period of time; (4) verifying, at the server and based on the first location data, the first event occurred in or near the first pre-defined geographic area; and (5) causing, by the server and in response to the verification, the first action to be performed.

In another aspect, a mobile telephone including a location infrastructure application configured to provide location information to a server, and receive responses from the server, is provided. The mobile telephone includes a location determining module configured to generate location information related to a position of the mobile telephone. In addition, the mobile telephone sends the location information to a server, and the mobile telephone receives from the server instructions to perform at least one action based on the location information sent to the server. Furthermore, creation of the instructions includes: (1) receiving, at a server for the location infrastructure application and from a client via a rules builder interface, a first selection specifying a first user context that includes detection of a first event involving a mobile telephone occurring in or near a first pre-defined geographic area; (2) receiving, at the server and from the client via the rules builder interface, a second selection, the second selection including a first action to be implemented by the location infrastructure application upon detection that all conditions specified by the first user context are satisfied; (3) generating, at the server, a first rule incorporating the first selection and the second selection; (4) storing, at the server, the first rule in a rules repository on behalf of the client; (5) monitoring, at the server over a first period of time, geolocation data of the mobile telephone; (6) determining, based on the geolocation data, that all conditions specified by the first user context have been satisfied; and (7) causing the first action to be performed via a mobile application running on the mobile telephone

In another aspect, a location infrastructure system is disclosed, the system including a mobile telephone. The mobile telephone includes a location infrastructure application configured to provide location information to a server associated with the location infrastructure application, receive responses and instructions from the server, and perform at least one action based on the instructions, and a location determining module configured to generate location information related to a position of the mobile telephone and send the location information to the server. The location infrastructure system also includes the server, comprising a processor and machine-readable media including instructions which, when executed by the processor, cause the processor to: (1) receive, at the server and from a client via a rules builder interface, a first user context selection to serve as a trigger for a first rule, the first user context selection specifying a first user context that includes detection of a first event occurring in or near a first pre-defined geographic area; (2) receive, at the server and from the client via the rules builder interface, a response selection for the first rule, the response selection including at least a first action to be implemented by the location infrastructure application upon detection that all conditions specified by the first user context selection are satisfied; (3) receive, at the server and from the mobile telephone, first location data for the mobile telephone over a first period of time; (4) verify, at the server and based on the first location data, the first event occurred in or near the first pre-defined geographic area; and (5) cause, by the server and in response to the verification, the first action to be performed.

In another aspect, a method of context-aware rules building for a location infrastructure application is disclosed. The method includes a first step of receiving, at a server for the location infrastructure application and from a client via a rules builder interface, a first user context selection to serve as a trigger for a first rule, the first user context selection specifying a first user context that includes detection of a first event occurring in or near a first pre-defined geographic area. A second step includes receiving, at the server and from the client via the rules builder interface, a response selection for the first rule, the response selection including at least a first action to be implemented by the location infrastructure application upon detection that all conditions specified by the first user context selection are satisfied. Furthermore, a third step includes receiving, at the server and from a first user device, first location data for the first user device over a first period of time. A fourth step includes verifying, at the server and based on the first location data, the first event occurred in or near the first pre-defined geographic area and a fifth step includes causing, by the server and in response to the verification, the first action to be performed.

In another aspect, a method of building a geolocation-based context-aware rule is also disclosed. The method includes a first step of receiving, at a server for the location infrastructure application and from a client via a rules builder interface, a first selection specifying a first user context that includes detection of a first event involving a first user device occurring in or near a first pre-defined geographic area. A second step includes receiving, at the server and from the client via the rules builder interface, a second selection, the second selection including a first action to be implemented by the location infrastructure application upon detection that all conditions specified by the first user context are satisfied. In addition, the method includes a third step of generating, at the server, a first rule incorporating the first selection and the second selection, and a fourth step of storing, at the server, the first rule in a rules repository on behalf of the client. A fifth step includes monitoring, at the server over a first period of time, geolocation data of the first user device, and a sixth step includes determining, based on the geolocation data, that all conditions specified by the first user context have been satisfied. A seventh step includes causing the first action to be performed via a mobile application running on the first user device.

In another aspect, a system for context-aware rules building for a location infrastructure application includes a processor and machine-readable media including instructions which, when executed by the processor, cause the processor to (1) receive, at a server for the location infrastructure application and from a client via a rules builder interface, a first user context selection to serve as a trigger for a first rule, the first user context selection specifying a first user context that includes detection of a first event occurring in or near a first pre-defined geographic area; (2) receive, at the server and from the client via the rules builder interface, a response selection for the first rule, the response selection including at least a first action to be implemented by the location infrastructure application upon detection that all conditions specified by the first user context selection are satisfied; (3) receive, at the server and from a first user device, first location data for the first user device over a first period of time; (4) verify, at the server and based on the first location data, the first event occurred in or near the first pre-defined geographic area; and (5) cause, by the server and in response to the verification, the first action to be performed.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIGS. 1A and 1B depict an overview of a scenario in which a client is using a rules builder user interface to create a rule (logic) for use in a location infrastructure application and in conjunction with a client software application, according to an embodiment;

FIGS. 2A and 2B is a schematic diagram depicting an environment by which the proposed embodiments may be implemented, according to an embodiment;

FIG. 3 shows a schematic flow diagram of inputs and outputs of a rules engine for the location infrastructure application, according to an embodiment;

FIG. 4 illustrates one example of a graphical user interface for rules building, according to an embodiment;

FIG. 5 is an example of a user interface in which a client can select the type of trigger event for their rule, according to an embodiment;

FIG. 6 is an example of a user interface by which the client can specify specific aspects or conditions that will be used to define the trigger event, according to an embodiment;

FIG. 7 is an example of a user interface by which the client can indicate other conditions that must be present or detected when the trigger event occurs, according to an embodiment;

FIG. 8 is an example of a user interface by which the client can select an action/response type (category) and then specify an action that is related to the selected category, according to an embodiment;

FIG. 9 is an illustration of a scenario in which a rule created by the client may be implemented in the real-world, according to an embodiment;

FIG. 10 is a flow chart depicting a process of context-aware rules building for a location infrastructure application, according to an embodiment.

### DETAILED DESCRIPTION

The embodiments describe a system and method that transforms how clients can manage and make changes to the way in which their application programming interface (API) interacts with a location platform. In one example, the location platform is provided as a location tracking and geofencing-based software development kit (SDK). The SKI is configured to interact with the client's API so that even those with no developer or coding experience can readily design and customize the way that geofence-data is employed. The systems and methods offer clients a streamlined and intuitive user interface that guides the client through each stage of the rule building.

For purposes of this application, an Application Programming Interface (API) can generally be understood to include a library of program elements such as functions, routines, protocols, or processes associated with a particular operating system or computing platform. The program elements may be software-based functions and/or processes in the form of source code, scripts, and/or executable code. The computing platform may include software and/or hardware. For example, the hardware may include a type of processor or hardware system. The software may include a version of an operating system such as Apple® iOS, MacOS®, Microsoft Windows®, Android® OS, UNIX, LINUX, or like environments that allow for running or executing an application and/or program. An API allow application programmers or providers to develop an application program capable of interfacing with the specified computing platform by incorporation of programs from the API library into the application program. A programmer may use a software development kit (SDK) or other tool to develop application programs. A development tool may include APIs or may enable the developer to remotely access APIs for a particular computer platform. Currently, most APIs are either openly accessible or include access control capabilities as part of the API.

As will be described in greater detail below, in different embodiments, the geofencing SDK can operate in conjunction with a dynamic rule engine that offers a rule builder interface that is intuitive while allowing for the creation and expression of highly nuanced and sophisticated rules that can be automatically implemented at each end-device based on location data obtained for individual consumers. The rules engine provides a user-friendly visualization interface, while enabling the geofencing SDK to respond dynamically to additional instructions from the API server as it manages the responses to each selected trigger event. In some embodiments, the proposed rules engine can reside on a remote cloud server, and communicate over a network with the SDK. In one example, the cloud server receives location updates from the SDK and responds with instructions like “change tracking options from X to Y” or “display notification X” based on the logic that was developed by the client using the rules engine interface. Thus, the SDK can receive requests for data and otherwise respond to instructions that are provided by the remote server, but developed step-by-step by the client themselves.

In different embodiments, the proposed rules engine (also referred to herein as a rules management system) can define, deploy, execute, monitor and maintain a variable and complex decision logic used by operational systems. The rule engine allows the logic (also referred to as rules) to be extracted and managed separately from other parts of the operational system, allowing a client of the SDK to specify new rules without the need to modify each part of the system on which the new rule may have an effect. More specifically, the proposed system allows the client to specify new rules without interacting with lines of code. Such a rule engine can be particularly advantageous where the requirements of the client are subject to a high degree or frequency of change, or where the decision used by the system is very complex, for example because it involves a large number of complex and interrelated requirements, or where consistency and traceability of actions or decisions made need to be tracked across a large group of users. However, in conventional SDK management, when a user of the SDK wishes to implement a change that relates to multiple existing rules, there is a significant overhead involved in identifying, modifying and testing each of the relevant existing rules to implement the change.

As noted above, the proposed rules management systems can be understood to work in conjunction with an SDK that can be installed in a mobile application (“app”). The geofencing SDK provides a location infrastructure that can collect location data either on-demand or on an ongoing basis, according to the established tracking options. The client can also stop tracking at any time. In different embodiments, the geofencing SDK allows clients to add geofencing, location tracking, trip tracking, geocoding, and routing to client apps and websites.

Conventionally, in order for laypersons to take advantage of the rich possibilities that can be implemented by this type of location infrastructure, at least some level of coding is required by the client, or the client must make a request to a developer with some expertise in API and software development. In other words, at each instance that a new or modified action is desired in response to some type of location data collected from an individual user (consumer), the client must engage in a coding event. In some cases, in order for a client to build their own location features often requires writing hundreds of lines of code, with cross-platform differences between iOS and Android. Simply for purposes of illustration, a sample code that is required to enable a location infrastructure to listen for geofence entry events and show notifications via an API is included below:

```
Sample code#
// AppDelegate.swift
import UIKitimport GeoSDK
@UIApplicationMainclass AppDelegate: UIResponder,
UIApplicationDelegate, GeoDelegate {
  let locationManager = CLLocationManager( )
  func application(_ application: UIApplication, didFinishLaunchingWith
Options launchOptions: [UIApplication.LaunchOptionsKey: Any]?) ->
Bool {
Geo.initialize(publishableKey: ″prj_test_pk_...″) Geo.setDelegate(self)
    self.locationManager.requestAlwaysAuthorization( )
    Geo.startTracking(trackingOptions: GeoTrackingOptions.
    presetResponsive)
    return true }
  func didReceiveEvents(_ events: [GeoEvent], user: GeoUser) {
UNUserNotificationCenter.current( ).requestAuthorization(options: [.alert,
.sound]) {
(granted, error) in if granted { for event in events { if event.type ==
.userEnteredGeofence { let content = UNMutableNotificationContent( )
content.body = ″You entered a geofence!″ content.sound =
UNNotificationSound.default content.categoryIdentifier = ″geofence″
      let request = UNNotificationRequest(identifier: event._id, content:
content, trigger: nil) UNUserNotificationCenter.current( ).add
(request, withCompletionHandler: { (_) in }) } } } }}
```

It can be appreciated that these lines of code would be beyond the ability of most non-developers, and the task of individually creating and launching a new rule would be both time-consuming and costly. This process would involve a longer waiting period for the client before the rule could be implemented, greater computing processing expenditures, and require employing personnel with some level of coding expertise. In contrast, the proposed embodiments offer a welcome alternative by which clients can independently and proficiently make decisions about what to do with their data and comprehensively define the manner in which these actions should occur. These decisions can be easy to put into action without deferring to an outside resource, and just as importantly, they can be easy to modify, update, and evaluate.

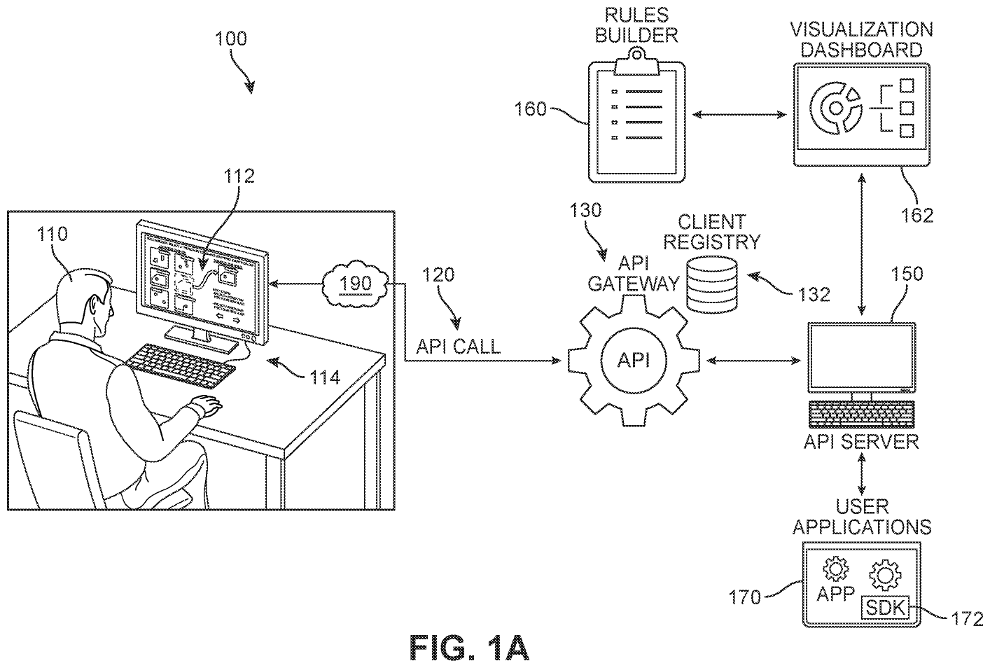

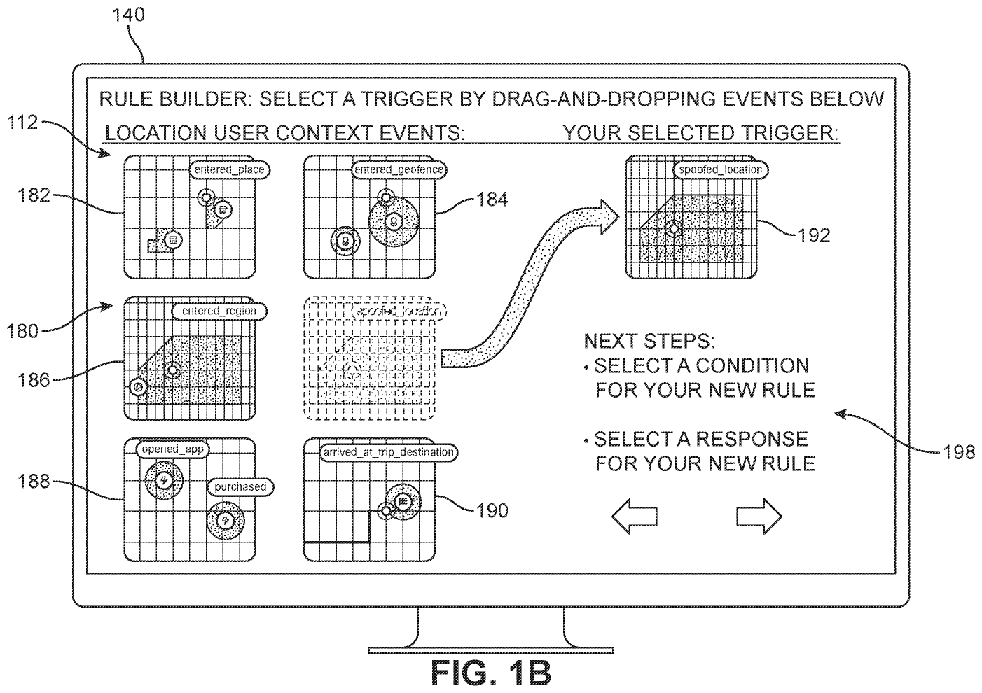

For purposes of clarity, an overview of one embodiment of the proposed systems and methods is illustrated with reference to FIGS. 1A and 1B. In FIG. 1A, an example of a first lay (non-coder) client (“first client”) 110 is shown interacting with an implementation of the proposed system is shown as executed via an API management environment (“environment”) 100. In this case, a computing device (client device 114) is associated with the first client 110, who in this scenario is depicted accessing a rules builder user interface (builder interface) 112. The client device 114 transmits an API call 120 to an API gateway 130 over a network 190. In some embodiments, the API gateway 130 can make reference to a client registry 132 to authenticate the first client 110 and/or identify what permissions the first client 110 has been allotted with respect to the API services that is being requested. The API gateway 130 can verify whether the first client 110 is authorized to make such requests (e.g., the owner of the API). In some embodiments, the API server 150 provides a visualization dashboard 162 by which the client can manage, review, and/or update the features and operations of their client application(s) 170 that are being supported by the API server 150. For example, the visualization dashboard 162 can provide visualization tools that monitor, analyze, and display key performance indicators (KPIs), metrics, and key data points for features provided by a location infrastructure in the client's applications 170 and associated projects. More specifically, in cases where the API server 150 works in concert with a geofencing-based SDK 172 as described herein, the visualization dashboard 162 can display data obtained by the SDK 172 as part of the metrics.

In some embodiments, the API server 150 can also determine whether the client requires the services of a rules builder module 160. In different embodiments, the rules builder module 160 of the API server 150 can present the builder interface 112 to the first client 110 as a component of the visualization dashboard 162, or as a separate interface environment. As will be described in greater detail below, the builder interface 112 serves as a tool by which the first client 110 can interact with and modify how the SDK 172 performs in conjunction with their applications 170. For purposes of illustration, one non-limiting example of some options that can be provided via the builder interface 112 is depicted in FIG. 1B.

In this example, a display 140 of the client computing device presents an embodiment of one of the stages of a rule building process that can be enabled by the builder interface 112. More specifically, the builder interface 112 includes a plurality of selectable options 180 on one side of the interface, and asks the client to select the trigger (user context event) that the new rule should be contingent upon. In this case, the selection can be made by dragging and then dropping the option onto the opposite side of the interface. For purposes of this scenario, the client has indicated the trigger should be location-dependent, and so they are being shown options by the system that reflect events in which the tracked user's location corresponds to some specified conditions. In this example, a first option 182 is a trigger based on when a person enters a specific type or category of place, such as a library, grocery store, school, etc. (“entered_place”), a second option 184 is a trigger based on when a person enters a designated geofenced area, such as a store that the client is invested in (“entered_geofence”), a third option 186 is a trigger based on when a person enters a particular region such as a zip code or city (“entered_region”), a fourth option 188 is a trigger based on when a person is already in a target zone or predesignated area and they perform an app-related activity, such as when they engage with the client app by either opening the app or completing a purchase through the app (“opened_app”, “purchased”), a fifth option 190 is a trigger based on when a person arrives at a preselected destination following a mapped journey using a calculated live ETA from an origin to a destination (“arrived_at_trip_destination”), and a sixth option 192 is a trigger based on when the system determines a person has spoofed their actual location using GPS spoofing, proxy and VPN usage, or device tampering. (“spoofed_location”).

It should be appreciated that the actions shown as plurality of selectable options 180 can include a wide array of events and event types beyond what is presented here, and those shown in FIG. 1B are included only for illustration. Furthermore, in some embodiments, the first client can be guided through a sequence of mini-tasks that collectively create a customized rule for implementation by the system. In other words, the rules building process provided via builder interface 112 can include a series of steps or interface-pages, where each section allows for client to define or select another aspect of their rule. In FIG. 1B, the client has selected the sixth option 192 by dragging and dropping the graphic icon representing spoofed location to the other side of the interface. in some embodiments, additional stages 198 can then be presented to the client via the builder interface 112 by which they can continue to build the rule per their desired conditions and outcomes. As shown in FIGS. 1A and 1B, this allows for a sophisticated yet simplified rule-build process that can be accomplished by the client without any coding work. This approach can greatly improve the performance of their own API by taking advantage of a broad range of context-aware services now made possible by custom and precise rule building.

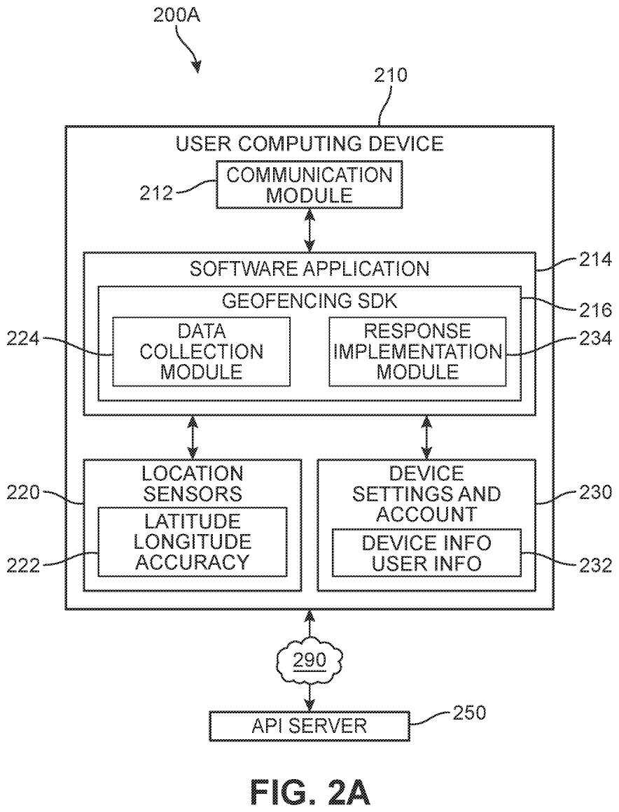

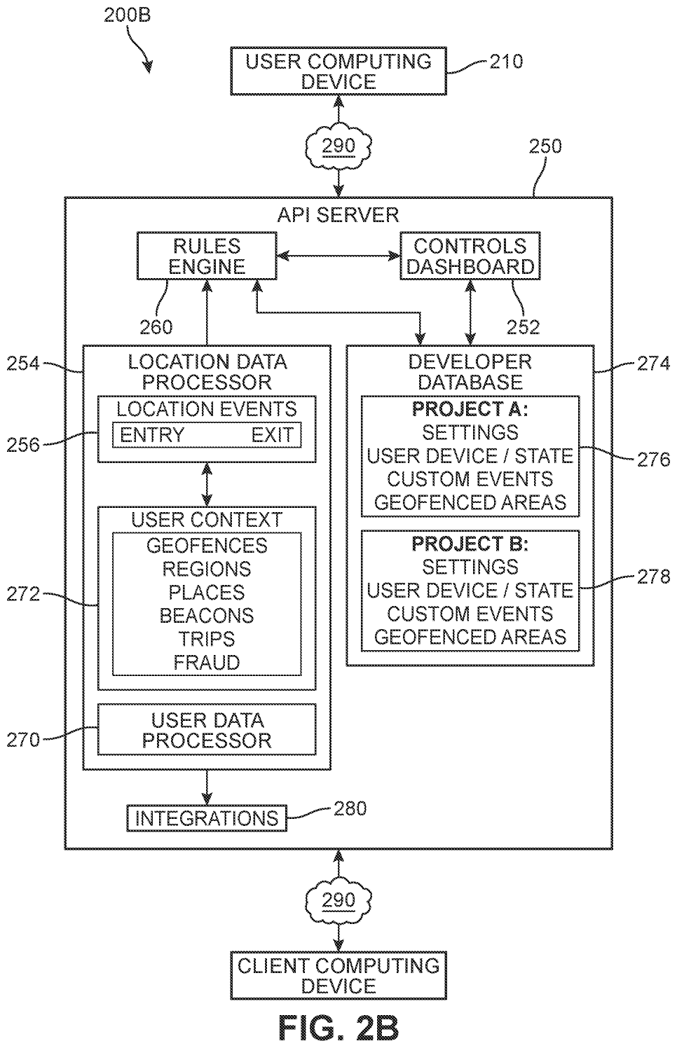

In order to provide the reader with a greater appreciation of the proposed embodiments, FIGS. 2A and 2B together depict an embodiment of an environment (200a, 200b, and collectively referred to as environment 200) by which the proposed rule building systems can be implemented. It should be understood that the environment 200 is presented is for purposes of illustration only, and other embodiments may utilize different or additional components or processes. The environment 200 may alternatively include additional, fewer, or different components. For example, the environment 200 may include additional storage devices, additional servers, additional computing devices, and other features not shown in FIGS. 2A and 2B.

The diagram of FIG. 2A depicts an embodiment of a user computing device (“user device”) 210 that includes an instance of a client software application (“client app”) 214 that includes an instance of a geofencing SDK 216 that provides the features and functions described herein. In different embodiments, the user device 210 can include an electronics unit comprising a plurality of different components, such as a user interface component (e.g., a touchscreen display, keyboard, mouse, microphone, speaker, etc.), a user interface module, a processor, and/or a communication module. The user device 210 may include a system including one or more processors and memory. Memory may comprise a non-transitory computer readable medium. Instructions stored within memory may be executed by the one or more processors. The user device 210 may be configured to receive and analyze data from various input sensors associated the user device 210 or data that is communicated from external components or devices to client device 132. In some cases, the user device 210 may also include a navigation system equipped with a GPS receiver that can receive GPS information or other receivers capable of receiving global or local positioning information.

A communication module 212 may allow the user device 210 to communicate wirelessly. In this case, the communication module is illustrated as a wireless connection; however, wired connections may also be used. For example, the communication module may include a wired serial bus such as a universal serial bus or a parallel bus, among other connections. The communication module may also include a wireless connection using Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

In different embodiments, the user device 210 includes a device display (“display”) that can, for example, present information and media for client app 214. In one embodiment, user device 210 could operate in a client-server relationship with one or more servers of a remote/cloud-based computer system. In some cases, user device 210 may run client software (including client app 214) through a web browser, in which case the client software may be hosted on a server associated with the computer system. In other cases, user device 210 may run client software in the form of a native software application that has been downloaded through a centralized marketplace (i.e., an “app store”). In some cases, while the client software that allows users to perform various tasks may be run on user device 210, the data may be retrieved from and stored on databases associated with the computer system.

In some embodiments, a mobile end-user can receive and send information through a user interface for the client app 214 that may be presented on the device display. In some embodiments, display may be a touchscreen, allowing the customer to interact with the user interface directly by touch. A user interface may refer to an operating system user interface or the interface of one or more software applications that may run on the user device 210. In some embodiments, the user interface can include a messaging window or other chat-space by which the user may review messages or other digital content.

In different embodiments, a mobile end-user's location and, to some extent their device activity, can be monitored and tracked through features provided by the SDK 216 installed in the client app 214. In some embodiments, the client app 214 can be downloaded to be accessible locally on the user device 210. In one embodiment, the client app 214 can offer a registration and profile interface (“interface”) for accessing and modifying settings associated with the app's operations, including privacy and notifications, as well as preferences regarding content presentation or user device controls.

In different embodiments, the client app 214 can be configured to offer content via native controls presented via an interface. Throughout this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. This can include selections or other user interactions with the application, such as a selection of an option offered via a native control, or a ‘click’, toggle, voice command, or other input actions (such as a mouse left-button or right-button click, a touchscreen tap, a selection of data, or other input types). Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video, or other such information presentation.

In different embodiments, the SDK 216 is in communication, via network 290, with an API server 250 (shown in greater detail in FIG. 2B) that provides a variety of location infrastructure and services. The API server 250 is also in communication with a client computing device (“client device”) 202, through which client end-users can manage and make changes to how the SDK 216 manifests and/or is configured to perform in or within their client app 214 at each user device. The client device 202 can also include an electronics unit comprising a plurality of different components, such as a user interface component (e.g., a touchscreen display, keyboard, mouse, microphone, speaker, etc.), a user interface module, a processor, and/or a communication module. The client device 202 may include a system including one or more processors and memory. Memory may comprise a non-transitory computer readable medium. Instructions stored within memory may be executed by the one or more processors.

As a general matter, the SDK 216 is installed in the client app 214 by the client. In one example, the SDK 216 can provide the functionality of a geofencing platform within the client app 214. In different embodiments, once the consumer (e.g., user device 210) grants location permissions to the client app 214, the SDK 216 can begin its tracking operations at the user device 210 and collecting data via a data collection module 224. For example, in some embodiments, the data collection module 224 can request and collect data from one or more device location sensors 220 that provides location information 222 (e.g., latitude, longitude, accuracy, etc.). In another embodiment, the data collection module 224 can request and collect data from one or more device settings and account information (“user device data”) 232 (e.g., device information and settings, user activity information, etc.).

In some embodiments, the SDK 216 can then send updates that include the user's location information and user device data to the API server 250. In some embodiments, based on the received location information, as well as additional data such as the location information for a previous time (location history for that user), device state information, and client project settings, the API server 250 can determine if one or more location events (e.g., “geofence entry or exit,” “place visit,” “trip arrival,” “country entry or exit,” “beacon entry or exit”, etc.) have occurred, as well as a corresponding user context (e.g., “user is currently in these geofences [list geofences by name/label]” “user is currently at this place [name of place]” “user is currently 5 mins away from this destination [name of destination],” etc.). The user context can be understood to be a more descriptive or nuanced narrative of the location event. While location events can indicate where the user device was based on the collected location data, and/or whether it was in some target zone or pre-defined geographical area that is of relevance to the client, the user context specifies exactly what the pre-defined geographical area is (i.e., its name or label) and describes in human-reader friendly language what the user device was doing relative to the detected area. In some embodiments, user context can be based on other, non-location type data, such as user device connectivity strength, battery life, or other user device sensor data. in some embodiments, a rule trigger can be composed of a location event, while in other embodiments, a rule trigger can be composed of a user context based on the location event, and in still other embodiments, a rule trigger can include either or both of a location event and a user context. Furthermore, while there is a large number of user contexts possible, in some embodiments, the system can classify these user contexts under a plurality of user context types. Additional information regarding various user context data types that may be determined from the collected user data by the API server 250 will be discussed with reference to FIG. 2B below.

In different embodiments, the API server 250 can return the identified location event and associated user context to the SDK, for example, to change the app experience based on location and/or context via a response implementation module 234. In other examples, as shown in FIG. 2B, the location event and user context can be stored in a database for reporting and analysis in a dashboard and/or sent to integrations. In some embodiments, such as during use cases involving pickup or delivery tracking, the SDK 216 can, in response to location data and user context indicating travel to a particular target destination, the system can cause the SDK 216 to start tracking the trip to the destination, which will include a calculation of an ETA to the destination geofence. Similar to tracking options, such trips can be (a) started and stopped in code on the client or (b) remotely started or stopped through integrations. The client can also stop a trip at any time or use the rules builder interface to define a period of time after which the trip tracking operation should cease. In some embodiments, the SDK 216 enables the generation of notifications in response to some location event and user context (e.g., the ability to display a push notification on geofence entry).

Referring now to FIG. 2B, additional details regarding the components and features of an embodiment of the API server 250 are presented by way of a schematic diagram. As noted above, in different embodiments, the API server 250 can receive location information and other user device data from the user device 210. In one embodiment, a location data processor 254 can receive and process the location information obtained from the user device 210 and determine whether any location events 256 have occurred (e.g., entry and/or exit from a specific boundary, such as a geofenced area or other place of interest as designated by the client). In addition, in some embodiments, the location data processor can define any relevant user context 272 based on the location data and a given project settings (e.g., see developer database 274 below) that can specify their geographical areas of interest.

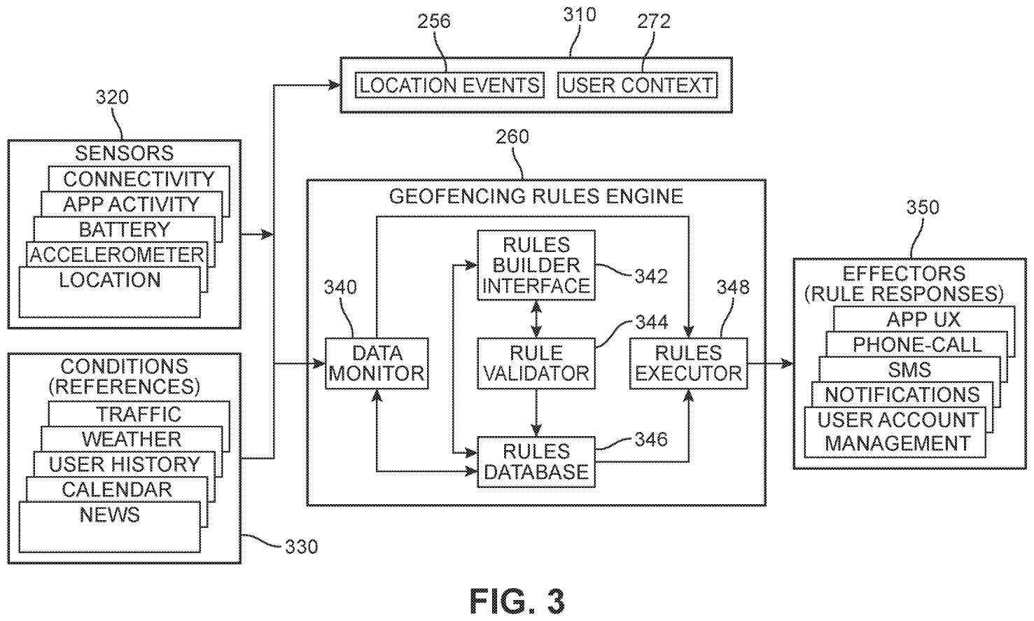

For purposes of this disclosure, the system can be configured to identify one or more user context types that can be used to classify the variety of user contexts that can be defined using the rules builder. In one embodiment, the classification under which a user context falls will be used to decide whether that user context should be presented in one part of the user interface or another part of the user interface for review/selection by the client. In different embodiments, these user context types can include (a) geofences, (b) places, (c) regions, (d) trips, (e) beacons, and (f) fraud. As noted earlier, the user context 272 allows the system to more descriptively and holistically contextualize the location event into a larger picture and/or evaluate the relevance of the location event with respect to the client's project. A client can then then refer to these contexts when defining each rule via the rules builder interface (e.g., see FIG. 3). The contexts can be grouped under one or more of the six user context types to facilitate the organization of the selections in the rules builder interface and streamline the client's user experience while building a rule.

Below, the meaning or significance of each context type will be provided in order to better illustrate how a client can employ the rules engine 260 to make selections that enable a nuanced approach to monitoring and tracking of each user's activity (location activity and/or device activity). In other words, the rules engine presents these context types to the client to make the rule building process easier and more intuitive. Each context type can include a group of location events or user contexts that can serve as triggers for the rule they are creating using the rules builder interface. In different embodiments, each user context event type listed below (geofences, trips, places, regions, beacons, fraud) therefore serves as a high-level navigation to a collection of events that can be selected by a client as a trigger when creating a rule via the rules builder interface.

As a general matter, geofences can be understood to represent custom-selected/bounded regions or pre-defined geographical regions or zones that have been created by a client in order to monitor user activity in relation to that area. Depending on the use case, a geofence event-based context might represent detection of a user entering/exiting a specific retail store, a neighborhood, as some non-limiting examples. In some embodiments, the SDK can generate a geofence entry event if a user enters a geofence or stops in a geofence with sufficient confidence, as well as a geofence exit event when the user leaves the geofence with sufficient confidence. A device must exit a geofence before a subsequent entry into that same geofence. The client can specify the metadata for geofences when the geofence is created, including the tag (a group for the geofence, e.g., store), external ID (an external ID for the geofence that maps to your internal database, e.g., 123), and description (a display name for the geofence, e.g., Store #123). This allows geofences to be uniquely referenced by tag and external ID, which can be referenced by the rule builder interface module when the client wants to create a rule that involves a specific geofence. Furthermore, in some embodiments, geofence events that are detected by the SDK can be associated with varying confidence levels. For example, confidence levels can range from 1 (low) to 3 (high), where confidence is a function of the accuracy of the location reported by the device and the geometry of the geofence. Confidence will be highest when the user, taking into account the accuracy of the location reported by the device, is completely inside the geofence. Confidence will be medium when the user is mostly inside the geofence. Confidence will be lowest when the user is only partially inside the geofence.

Furthermore, clients can use the SDK to define user contexts for “trips” that a user may undertake and thereby calculate live ETAs from an origin to a destination. Trips can encompass several location events, such as a user starting a trip, trip modification/update, approaching trip destination, arrived at trip destination, and trip stopped. Detection of these events is particularly useful in pickup or delivery tracking. A client can create a destination geofence, and then use the SDK to generate trip events with ETAs to the destination geofence. As the trip progresses, the status associated with that user will update from started to approaching (based on the approaching threshold selected by the client), then arrived (on destination geofence entry). In some embodiments, the SDK can provide a delay detection feature that identifies trips at risk of being delayed or incomplete based on the client's selected delay threshold. In another example, a wait time can also be calculated based on the duration between the moment when a user arrives at a destination (user.arrived_at_trip_destination) and the moment when the trip is marked complete (completed), showing how long the user had to wait before their order was delivered to them. Each of these trip-related events can be presented by the rules engine 260 as potential triggers that may be selected by the client when building their rules.

With respect to the user context type of places, clients can request that the SDK monitor and track user device 210 to detect when they visit a place, chain, or category (regardless of whether a geofence has been created for that location) by reference to an internal points-of-interest (POI) database associated with the API server 250. In such cases, a user's interaction with the selected places can serve as trigger events. The POI database includes millions of places around the world from open and commercial datasets, with coverage for major chains (such as McDonald's® or Walmart®) and categories (like airports or stadiums), often with accurate polygon geometry and additional metadata like address or operating hours. The places can also be classified into categories, such as “chains” (e.g., Starbucks) so that a client can simply select the chain name and all locations where that chain has a location when defining their trigger event via the rules builder. In some embodiments, the SDK generates events based on a user entering one of these POI places, or exiting one of the POI places. For example, the SDK can generate a place entry event if a user stops at a place (i.e., when “stopped” is “true” based on the selected tracking options) and matching client filters with sufficient confidence, then a place exit event when the user leaves the place with sufficient confidence. Similar to geofence events, place events can be associated with confidence levels. In one example, confidence levels range from 1 (low) to 3 (high), where confidence is a function of the accuracy of the location reported by the device, the footprint of the place, the density of the area, the popularity of the place, and other signals. Thus, a client can select a place event as a trigger in the rules builder, but also narrow the trigger by requesting that place events below a selected confidence level be ignored.

Events can also be classified based on a region user context type. For example, the SDK and location infrastructure described herein can access a boundary database to detect a user's country, state, DMA (media market), or postal code. In some cases, the region detection tool can also be used to allowlist or blocklist location updates in specific countries for privacy or compliance reasons. In another example, region events can be issued in response to detection of the user device in the user's home regions based on location updates in the last 30 days, and detect when a user is traveling outside of their home regions. Thus, a client can select a region event as a trigger in the rules builder to cause some action when the client enters or exit a specific country, or enters or exits some bounded area or zone around their home location.

In another example, events can be grouped in a beacon context type based on whether the user moved in or out of a zone that has been created by clients via on-site Bluetooth® (and/or Near Field Communication (NFC) technology) beacons. In some cases, the SDK can detect any nearby Bluetooth® beacons that serve as hardware-enabled micro-geofences, accurate down to a few meters. For example, someone might create a store-level geofence and request that the SDK monitor user device traffic near beacons installed at the entrance, in the drive-thru, on registers, on tables, in aisles, or in parking spaces at each store. In some embodiments, the creation of beacons can be made by the client via the visualization dashboard, CSV import, or through the API. Similar to geofences, metadata for beacons are provided by the client when they create them, including a tag (a group for the beacon, e.g., store-register), external ID (an external ID for the beacon that maps to your internal database, e.g., 123-1), and description (a display name for the beacon, e.g., Store #123-Register #1).

In different embodiments, the system can also be configured to classify certain user data events as being of a fraud user context type. For example, the client can build a rule that relies on the ability of the SDK to detect one or more of GPS spoofing, proxy and VPN usage, and device tampering. In some embodiments, the determination that fraud has occurred can be used in conjunction with a region such that the system detects a user's country and state and mark specific regions as allowed or denied to comply with regulations. The API server 250 can collect a variety of fraud signals and perform fraud and jurisdiction checks, calculating flags that you can use for fraud detection and geo-compliance in the client app, including (a) mocked: Indicates whether a user's location is being mocked, such as in a simulator or using a location spoofing app; (b) compromised: Indicates whether the user's device or app has been compromised; (c) jumped: Indicates whether the user moved too far too fast (e.g., “jumped” across the country in only a few seconds); (d) sharing: Indicates whether the user is screen sharing; (e) proxy: Indicates whether the user's IP address is a known proxy, VPN, Tor exit node, etc.; and (f) verified: Indicates whether the request was made with SSL pinning configured successfully. While the client can define a rule that is triggered in response to any one of these individual flags, the rule builder can also allow the client to define a trigger based on whether a single user has passed all fraud checks.

In different embodiments, a given client can identify a plurality of events and create many geofences for a given project. In one embodiment, such data can be stored in developer database 274. In some embodiments, the client may implement multiple projects (e.g., Project “A 276, Project “B” 278, etc.) that each track and monitor different user device state events, and/or have differently defined custom events and geofenced areas. Some examples of custom events include custom non-location events like “app open” or “purchase” that can be enriched with location context additional reporting and analysis (e.g., “where are users opening my app?”). Custom events are defined by the client in conjunction with their software application. Thus, the possible events that may be selected following the custom event selection is based on the individual client's software and its features. In other words, each feature can be tagged and used to define a trigger event (e.g., “app opened three or more times in a day”, “clearance items page accessed while in store”, “mobile app accessibility settings updated while traveling”, “mobile app stored payment options modified”, “purchase made of $50 or more”, “coupon code XCKWR applied”) that can be used to cause the system to perform one or more actions in response to detection of data indicating the trigger event has occurred.

In some embodiments, a user data processor 270 can receive and process the user device data obtained from the user device 210 to determine when specific in-app activity is occurring (e.g., opening app, closing app, adding items to cart, starting a return, requesting customer service assistance) as well as determine the user's status based on sensors onboard the user device 210 such as whether they are traveling, walking, driving (can be used to trigger whether certain media content will be shown to the user, e.g., when user has stopped the car), have low battery or high battery (can be used to trigger whether certain media content will be shown to the user), have low connectivity or high connectivity (can be used to trigger whether certain media content will be shown to the user), etc.

Each project can also include different rules, based on the activity being monitored and the triggers+responses selected by the client for that project. In some embodiments, the rules for each project can be stored in the developer database 274 and accessed by the rules engine 260, while in other embodiments, the rules may be stored by the rules engine 260. As shown in FIG. 2B, in some embodiments, the location event and user context can be stored in developer database for reporting and analysis in dashboard 252 (for example, to measure foot traffic or do user segmentation), and optionally sent to integrations 280 like webhooks (for example, to send a location event to an external system).

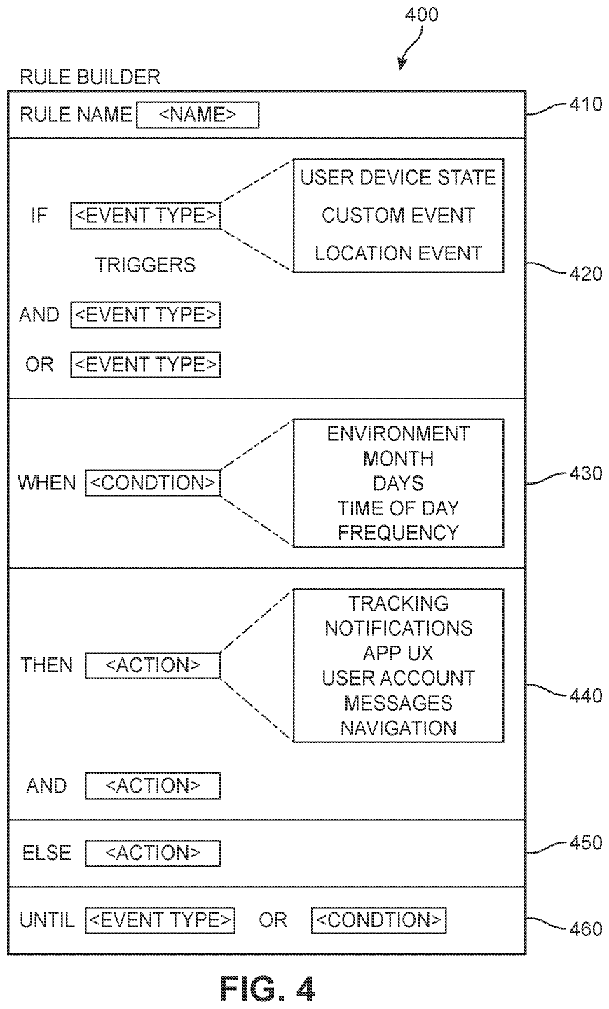

Additional details regarding the performance of the rules engine 260 are now provided with reference to the schematic flow diagram of FIG. 3. In FIG. 3, it can be seen that the rules engine 260 includes a rules builder interface module 342 by which a client can develop, manage, review, and visualize their custom rules. As will be shown in FIGS. 4-8 below, the rules builder interface module 342 offers clients an interactive, visual tool by which they can, with precision, build a rule for implementation by the location infrastructure, without the need for any coding. These rules can then be executed at one or many user devices whenever the specified trigger event is detected.

In different embodiments, as a user creates and submits a rule via rules builder interface provided by the rules builder interface module 342, a rule validator module 344 can verify that the rule that has been pieced together is consistent and logical. If so, the rule can be stored in rules database 346 (and/or at the developer database of FIG. 2B). If the rule is inconsistent or somehow clashes or conflicts with already-existing rules, the client will be notified and the rule will be saved as a “draft” rule for review by the client along with a description of the inconsistencies. Once a rule has been created by the client, a data monitor module 340 can monitor incoming data including, but not limited to, collected data 310 such as location events 256 and user context events 272. Furthermore, in some embodiments, the rules engine 260 can access additional data from the user device in order to make decisions regarding whether a rule should be triggered or not. This data can be obtained via one or any of a user device's onboard sensors 320, including further location data, accelerometer data, battery life data, user app activity data, and connectivity strength data. In addition, in some embodiments, the rules engine 260 can access additional data from external knowledge sources and databases in order to make decisions regarding whether a rule should be triggered or not, including traffic data, weather data, calendar data, news data, and a user's past location events and app activity history (see below).

This array of data can be monitored by the data monitor 340, which can determine when a trigger event has occurred in the scope of a given rule. If a rule has been triggered, a rules executor module 348 can cause the one or more actions that were selected as desired responses to these triggers to be performed at the user device or by the API server. In some embodiments, such outcome-actions can be implemented by effectors 350 associated with the user whose information was used to identify the trigger, for example actions performed via the client app (e.g., a change or feature activation in the user's app experience at the user device), via their telephony (e.g., receive a phone call at the user's number with custom voice content), SMS (e.g., transmit a direct text or MMS message to the user with custom media content), notifications (e.g., auto-generate and transmit an e-mail to the user's e-mail account with selected media content such as a coupon or offer, auto-produce a specific postcard or letter that is mailed to the user's address, cause an in-app notification, a locked screen message, or a banner message on the user device that includes a custom message, code, and/or link to a website), and/or via the user's account manager in the API server which can alter or block the user's account settings, block the user from accessing the app, upgrade the user's membership status, etc.

For purposes of clarity, FIGS. 4-8 depict a series of user interfaces that illustrate an example of a rule building experience for the location infrastructure described herein. In FIG. 4, an overview of a rules builder user interface (“builder interface”) 400 that can be presented to a client as generated via the rules engine. In different embodiments, the builder interface 400 includes a sequence of rule building stages, each stage comprising a rule component. It should be understood that the builder interface 400 layout is not limited to the layout depicted in the drawings. In other words, in other embodiments, the arrangement of the various options and rule components can differ. Furthermore, in different embodiments, the mechanism by which selections can be made can differ; for example, rather than a series of drop-down menus as shown in the drawings, the options can alternatively be shown as graphical drag and drop user interface that allows clients a visual means by which to pick up and move elements (options) for each rule component, as well as radio buttons and/or segmented controls (where all options are visible at once), checkboxes, toggles, a date picker interface for dates, user input boxes for users to type their selection, a “start typing” interface where a list of filtered options is displayed after the client enters the first one or two letters, tabs for segmenting each rule component in the sequence from the next, a stepper interface, a slide interface, the ability to sort or filter options that will be shown in a drop-down list, or a mixture thereof. In some cases, dropdown menus may be preferable to some clients as they automatically validate the input.

In FIG. 4, the builder interface 400 includes a first rule component 410 (Rule Name) where the client can assign a name to the rule being built below, a second rule component 420 for the client to describe the trigger(s) for this rule, a third rule component 430 for the client to optionally identify one or more conditions that should be present before the trigger can cause a response, a fourth rule component 440 for the client to select one or more responses that should be implemented by the rules executor module when the trigger actions and conditions (if any) have been detected, a fifth rule component 450 to provide clients an opportunity to maintain some response in cases where the rule's trigger does not apply, and a sixth rule component 460 for the client to optionally establish an “end” time or condition designating when the response that has been triggered should be terminated.

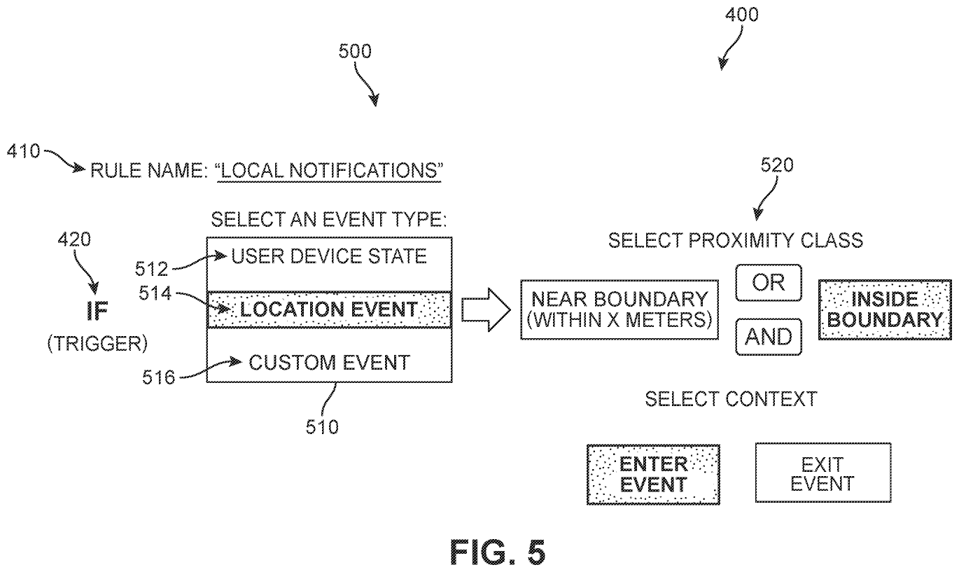

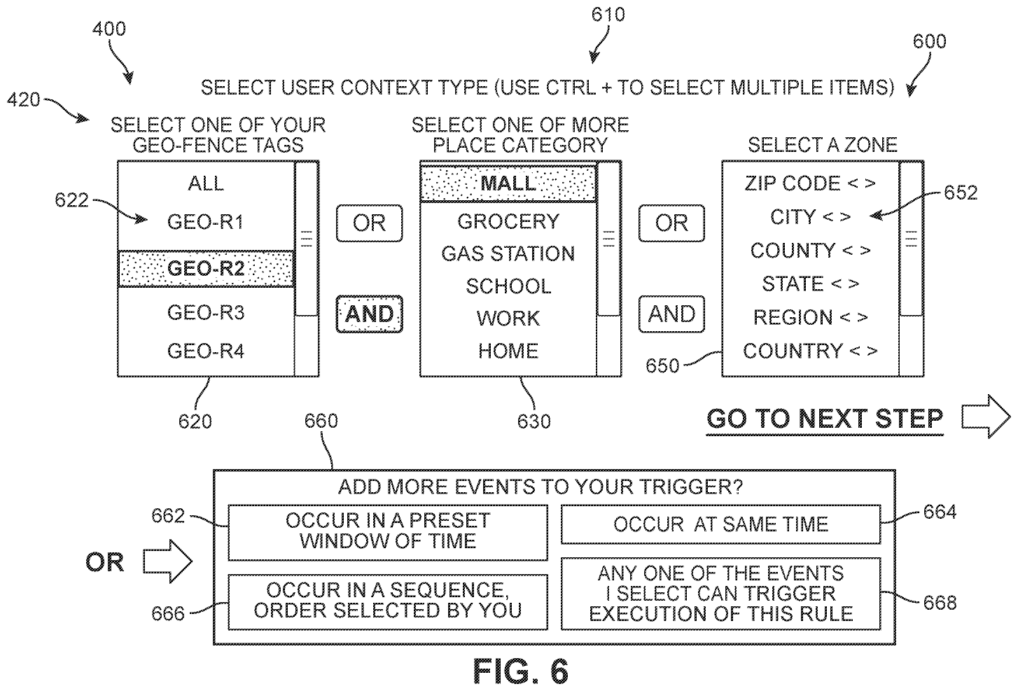

Additional details regarding embodiments of each of the rule components and their graphical user interface (GUI) user experiences are provided with reference to FIGS. 5-8. In FIGS. 5 and 6, an example of a GUI for the first rule component 410 that can be presented by the rules builder user interface is shown. In a first stage 500, the builder interface 400 can include an event type selection tool 510 that offers selectable options for filtering the possible trigger events. In this example, the event types include user device state events 512 (e.g., detection of the user making an in-app purchase), location events 514 (e.g., detection of a location-based context event, as described above in FIG. 2B, and custom events 516 (e.g., detection of an event custom-designed by the client). The builder interface 410 further allows the client to establish whether the trigger occurs when the user is near or within the boundary for any selected location event via a proximity tool 520. In some embodiments, the client can be provided with the ability to designate that proximity should include only one of these options (“or”) so the event occurs only if the user is near the boundary but not in the boundary or vice-versa, or that proximity should include both of these options (“and”) so that the event can be detected if the user is in the boundary or near the boundary. Furthermore, the client can select whether the trigger should be based on the user arriving (entering) the specified zone, or leaving (exiting) the specified zone. In some embodiments, the builder interface 400 can allow the client to further refine the trigger event by requiring that the user be in the specified zone for “X” period of time (e.g., a visit time of at least 1 minute, 5 minutes, 30 minutes, one hour) before the rule's response should be executed.

In different embodiments, once the client selects their overall trigger type, they can move to choosing a specific event that falls under the selected trigger type, as depicted in a second stage 600 illustrated in FIG. 6. This aspect of the first rule component 420 includes an event selection tool 610, in this case offering various location-related events (based on the client's selection of location events 514 in FIG. 5). In some embodiments, the events can be grouped into different option sets based on the user context type to facilitate the client's navigation through the options. For example, in FIG. 6, a first user context type tool 620, a second user context type tool 630, and a third user context type tool 650 are shown. The first user context type tool 620 includes options corresponding to geofences 622 that have been created by the client for the current project, listed by their geofence labels (designated by the client). In this case, the client selects a second geofence (“Geo-R2”) shown in the list. The second user context type tool 630 allows the client to choose from one or more place categories 632 (e.g., Mall, Grocery, Gas Station, School, Work, Home, etc.). As described earlier, such place categories can be based on a POI database. In addition, the third user context type tool 650 enables the client to define their trigger based on already known or defined regions zones 652, such as zip code, city, county, state, region/territory, country, etc. Once the client clicks on one of these options, they can be shown a field in which they can type or otherwise provide the value for that type of zone (e.g., type in the zip code when zip code is selected).

In some embodiments, the different types of user context events can be combined (e.g., using AND/OR conditions). For example, in FIG. 6, the client has selected both a geofence and a place (mall), with an AND connector. This can indicate to the system that the trigger event should correspond to detection of the user device near or in a mall that includes the selected geofenced zone (e.g., a specific store chain location).

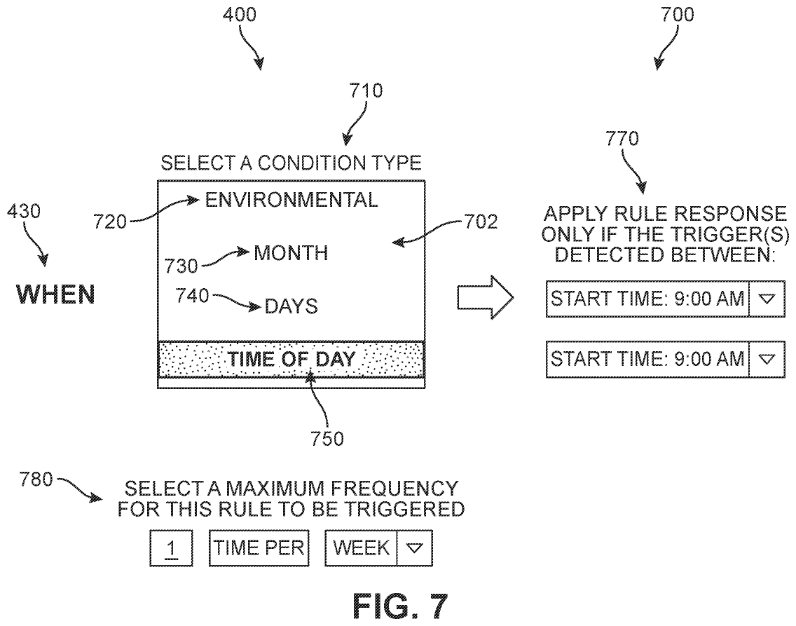

After the client has entered their desired parameters for the trigger, they can move on to a next step involving the third rule component, as shown in FIG. 7. However, in some cases it can be appreciated that a client may desire the creation of a rule with multiple triggers. Thus, in some embodiments, the builder interface 400 can include an optional menu 660 that allows the client to repeat the process described in FIGS. 5 and 6, as well as define how the multiple events might collectively register as a trigger for the rule. In FIG. 6, the menu 660 asks the client if all of the selected events must occur within a limited window of time (first option 662), occur at the same time (second option 664), occur in a specific order/sequence (e.g., one event must occur after the other) (third option 666), and a broader ‘any’ event option (fourth option 668) to allow for any of the selected events to serve (independently) as the trigger for this rule.

As the trigger has been selected and fine-tuned in FIGS. 5 and 6, the builder interface 400 can provide tools to a third stage 700, depicted in FIG. 7. In some embodiments, the third rule component 430 can involve more nuances aspects of the rule building process. For example, an optional condition type selection tool 710 can allow the client to select one or more conditions or circumstances that must be true (e.g., by reference to user device and/or an external knowledge base) when the event occurs for the rule to be triggered and its response implemented. In one embodiment, the condition type selection tool 710 includes a set of conditions including a first condition 720 to select an environmental factor (e.g., it is raining where the user is located, there is a traffic accident at/near the user's location, there is a natural disaster predicted in the next day around the user's location, etc.), a second condition 730 to select specific month(s) during which the event must have occurred, a third condition 740 to select specific day(s) of the week on which the event must have occurred, and a fourth condition 750 to select a time of day during which the event must occur. In this case, the client has selected the fourth condition 750 and a new GUI has appeared in the form of a time-of-day selection tool 770, which allows the client to designate the window of time that the event must occur in order for the event to be deemed a trigger event. The time-of-day selection tool 770 includes options for selecting a start time and an end time. in some embodiments, multiple conditions can be selected, and the builder interface 400 can then allow the client to indicate more precisely in what circumstances and time the event can register as a trigger in the context of this particular rule.

Furthermore, in some embodiments, a frequency selection tool 780 can allow the client to limit the number of times that the response is implemented over the course of some period of time. Thus, in this case, the client indicates that the response selected should only be implemented a maximum of once per day-even if the trigger event occurs more frequently than that on that day. Other frequencies are also easily indicated by this tool, where the drop-down menu allows the client to define periods of hours, days, weeks, months, years, etc. Other custom tools can also be provided by the builder interface 400, such as a wait time selection tool that allows the client to define any duration of time (e.g., immediately, one minute, five minutes, one hour, one day, one week, etc.) after which the response should be expressed. In other words, in some embodiments, the client can request that once a trigger has been detected, the system should delay implementation of the corresponding response for some period. For example, this can be useful in cases where the client is a merchant and wants to obtain the user's feedback about some shopping experience but not immediately after the purchase event.

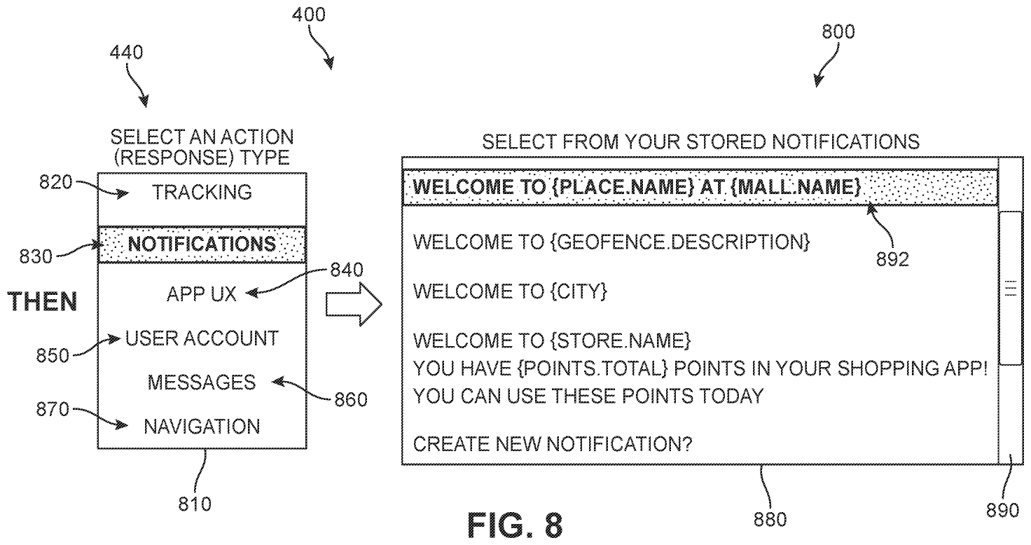

As noted earlier, each rule that is built by a client can define when and in what circumstances a specific action should be executed. In many cases, this action will be effected at the user's device. For example, an action can be generated in the user's device in response to a signal transmitted by the rules executor module and sent to the user's device over a network connection. In another example, an action can be executed at the API server, such as in cases where the action selected is a modification of the user's account. Referring next to FIG. 8, an example of a fourth stage 800 of the rule building process involving the fourth rule component 440 is depicted. As shown in FIG. 8, the fourth rule component 440 involves the response that will be executed if the selected trigger event is determined to have occurred. A GUI comprising an action type selection tool 810 can be presented to the client that includes a set of action-categories, such as tracking 820, notifications 830, app UX 840, user account 860, messages 860, and navigation 870. Upon selection of any one of these categories, the builder interface 400 can cause a presentation of a secondary menu 880 that lists specific actions 890 under that category that can be added to the rule. For purposes of this example, the client selects notifications 830, and then selects a first notification action 892 that will cause a notification to be shown at the user's device in response to the event detection.

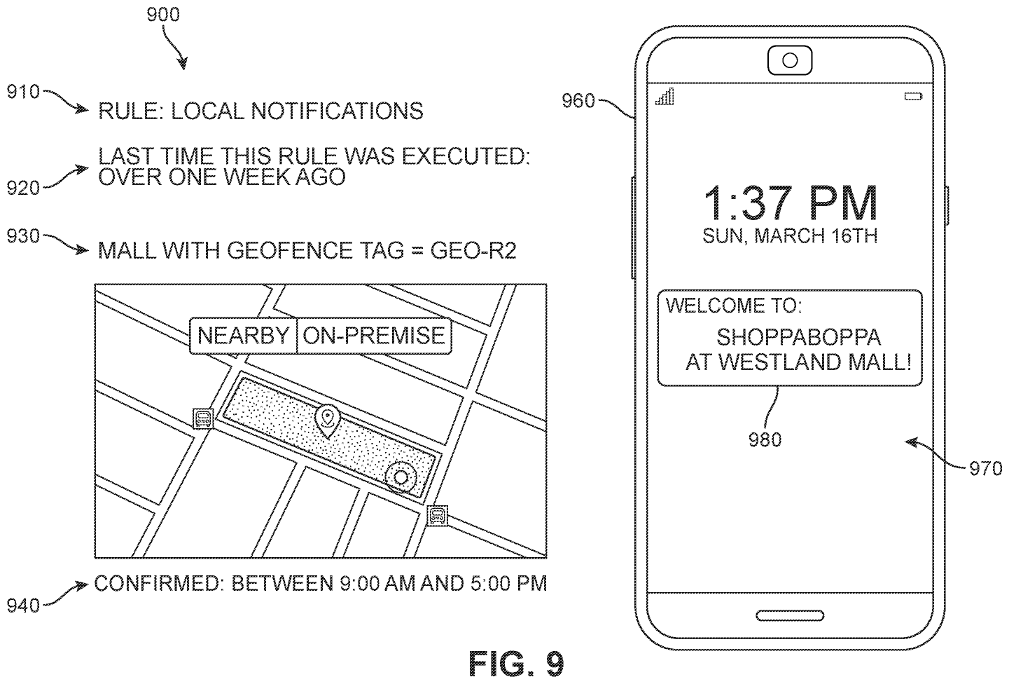

For purposes of illustration, a scenario 900 in which the rule created during the rule building process shown in FIGS. 5, 6, 7, and 8 is now depicted in FIG. 9. In this scenario 900, the rules engine can receive information from a variety of sources, including user device 960 and internal and external databases and knowledge repositories. By reference to its rules database, the rules monitor module determines that a first rule 910 (“Local Notifications”) has been triggered. This assessment and decision can be based on a series of conditions that were defined by the first rule 910 being met or passed with respect to the incoming tracking and monitoring data for each user device. In a first condition 920, the system can determine that the first rule 900—which has a frequency limitation of once per week—has not been applied for at least one week. In a second condition 930, the system determines that the first rule 910—which is contingent on location data indicating the user device has entered a mall in which a geofenced area type Geo-R2 is present—is potentially triggered, as long as any other related conditions defined by the rule have also been met. The system can verify the user device is actually within the boundary of the mall (rather than simply nearby), as defined by the first rule 910. Finally, the system can determine this event has occurred within the time span represented by a third condition 940 (between 9 am and 5 pm). Once the data confirms that each condition has been met, the system can cause the selected action for the first rule 910 to be implemented. This is illustrated at user device 960, where the system causes a notification 980 to be presented at a display 970 of the user device 960 that includes the content selected (“Welcome to ShoppaBoppa at Westland Mall”).

As described herein, a client seeking to extend the capabilities of their mobile software application can incorporate a location infrastructure application's SDK for geolocation-based context-aware rule building. More specifically, a client with little to no programming experience or coding background can employ the disclosed tools and readily create and manage their custom rules for each of their projects and across their wide spectrum of users. Simply for purposes of illustration, some examples of these rules are now described below. It should be understood that these examples are only to better represent the scope and range that is possible by implementation of the proposed systems and methods, and is not intended to limit the type of rules that can be created in any way. Furthermore, once a client has created a rule such as those below with a particular use case, the investment of time and effort to enable a second, third, fourth, and more use case based on the same rule is negligible and requires no further lines of code. Instead, the client simply returns to the rules builder interface, opens the rules manager at their dashboard which lists all of their current and draft (in progress) rules, and selects the rule for duplication in a different use case. Rules can be quickly modified, deleted, duplicated for other use-cases, combined, and split.

In one example, in some embodiments, a client for a retail/shopping mobile app can employ the rules builder interface to request nearby notifications, such that when a particular user (or user group) has a user context where they are near a place with “category=mall” that contains a geofence with “tag=store”, the system should cause a notification to display (at the user device) that includes content such as “welcome to {place.name}” notification in the app, with a limitation of this rule being triggered set to a maximum of one time per user per week. In another example, a client for a restaurant software application can create a rule using an embodiment of the rules builder interface to narrow the trigger selection as a custom event and then select the option when the user “opens app” while in a geofence with tag=restaurant or another geofence, POI, region, etc., the system should cause the user's device to display a “welcome to {geofence.description} notification” in the client app. As a third example, a travel company client can create a rule using the rules builder interface to generate location-based reminders for users, such that if the system detects that a user is traveling (user context=traveling), the system should cause the tracking options for that user to shift to a responsive mode (more frequent check-ins), and if the user device does not indicate the user is traveling, the tracking options can be set to an efficient mode (battery conservation, less frequent tracking updates). In some case, there may be an ‘AND/OR’ type of condition added to such a rule, whereby if the user is traveling and at an airport, the system should also cause the user device to display a “welcome to {city}” notification. In a fourth example, for clients managing retail and/or restaurant apps where curbside pickup or drive-thrus are a feature of their services, the client can go to the rules builder interface and select the trigger type as “custom event” and then specify the event as “order placed”. In response to detecting an order has been placed by a user at the client app, the rule can instruct the system to start a continuous tracking mode as well as start a trip to the destination geofence. Similarly, the same client can create another rule with a custom event “order complete” and select the options where tracking should be ended and the trip terminated when the order is complete or after one hour, whichever comes first. In a fifth example, a logistics app client can employ the rules builder interface to create worker tracking rules. For example, they might select a custom event of “shift started,” and then select a action of starting continuous tracking mode and/or starting a trip to the destination geofence in response to detecting the start of a shift for a worker (user). Similarly, another rule can be created whereby when a custom event “shift stopped” is detected, the system should stop tracking and stop the trip. In a sixth example, a client can create rules for privacy that are automatically triggered; for example, the client can indicate via the rules builder interface that for the user context of entering a blacklisted country or state, there should be a responsive action whereby the system blocks the SDK from performing location updates and also stop location tracking. In a seventh example, a client can define a rule where the detection of one or more fraudulent location updates in a given period of time should trigger actions of (a) blacklisting (blocking) of that user, (b) stopping tracking of this user, and (c) send an email to a security contact as identified by the client in the rules builder interface data entry field (e.g., security@mycompany.com). In other cases, the client can create rule that intelligently and dynamically responds based on changes in a user's device's store modes, location-based messaging, arrival detection, order firing, and foot traffic attribution.

In still other embodiments, the user can be provided with a visualization dashboard and select one of a set of options that can be dragged and dropped into an operation queue. In some cases, the options can be generated based on the user's own text description (e.g., “I want to know whenever my customer is at a movie theater”→auto-generates a block that performs this function that the user can drag into the queue). Each option can indicate how the system should respond when a specific type of data is registered. For example, a user can tailor-create explicit scenarios for remote tracking of some or all of their customers that are based on a curated set of rules. In one embodiment, the user can fine-tune the level of geofencing accuracy and/or frequency that is applied to each operation. There can be different operational modes based on specific user activity, such as the user's location (e.g., for the client McDonald's, present a first type of information to the customer when the customer is within two miles of any McDonald's franchise, a second type of information when the same customer is pulling into a competitor such as Burger King or Wendy's, a third set of information when the customer is entering a food court where one of the venues is a McDonald's, a fourth set when in the parking lot of a McDonald's). The rules can be easily trackable by the end-user and visualized using a sequence of blocks similar to various Block Coding applications.

Other possible levels of detail include using the rules engine to create rules based on specific parts of the store the customer is in or enters/exits. As an example, if the customer is shopping at Wal-Mart and enters the clothing area, there may be a first rule executed, while the same customer entering the hardware aisle has a different, second rule that will be executed, and the same customer leaving the hardware aisle has a third rule that is executed, and the customer moving into the Groceries section may have still another fourth rule that is executed. In still another example, the user can establish rules based on whether a customer historically moves in a particular pattern through the store or other shopping environment and in one instance breaks the pattern, the system displays a reminder (e.g., “Did you forget cat food?”). The level of specificity implemented could be tailored by the end-user; by using the visualization dashboard they can easily see what actions will be performed in response to selected data.

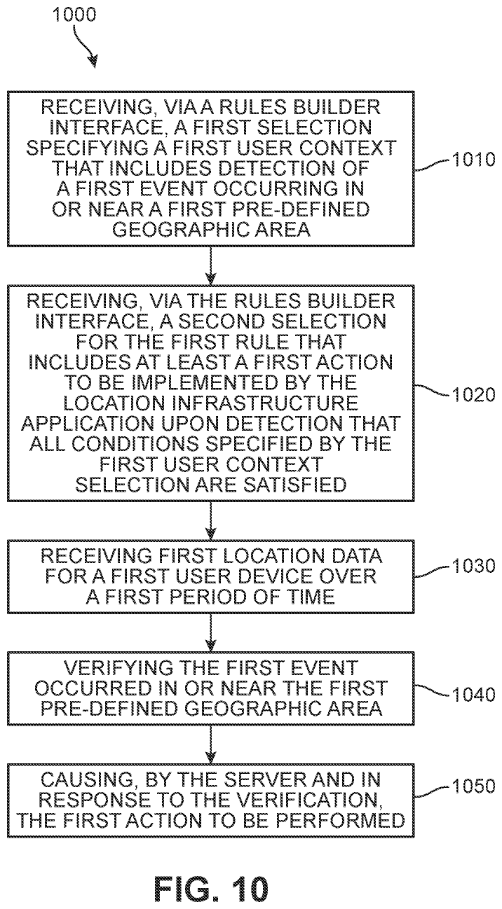

FIG. 10 is a flow chart illustrating an embodiment of a method 1000 of context-aware rules building for a location infrastructure application. The method 1000 includes a first step 1010 of receiving, at a server for the location infrastructure application and from a client via a rules builder interface, a first user context selection to serve as a trigger for a first rule, the first user context selection specifying a first user context that includes detection of a first event occurring in or near a first pre-defined geographic area. In some other embodiments, the first step 1010 can be location-independent, where the client makes a first user context selection that serves as a trigger based on any desired event regardless of geographic area. For example, certain times of day or days of the week, specific months, etc. can be used to cause the SDK to start some response (e.g., trigger active location tracking of an end-user's device, regardless of the device's current geographic location).

A second step 1020 includes receiving, at the server and from the client via the rules builder interface, a response selection for the first rule, the response selection including at least a first action to be implemented by the location infrastructure application upon detection that all conditions specified by the first user context selection are satisfied. Furthermore, a third step 1030 includes receiving, at the server and from a first user device, first location data for the first user device over a first period of time. A fourth step 1040 includes verifying, at the server and based on the first location data, the first event occurred in or near the first pre-defined geographic area and a fifth step 1050 includes causing, by the server and in response to the verification, the first action to be performed.

In other embodiments, the method may include additional steps or aspects. In some examples, the method includes an additional step of transmitting a signal to the first user device that causes the first action to be performed via a mobile application running on the first user device. In one example, the signal is received by a software development kit (SDK) associated with the location infrastructure application that is installed in the mobile application. In some embodiments, causing the first action to be performed includes modifying an account setting for a first user associated with the first user device. In different embodiments, the rules builder interface includes a graphical user interface (GUI) menu offering selectable options, each selectable option designating one of a set of pre-defined user context types from which the first user context selection was made. In one embodiment, the pre-defined user context types include one or more of a geofence context type, a beacon context type, a trips context type, a regions context type, a place context type, and a fraud context type. Selection of a user context type can then cause the builder interface to present an additional menu with selectable options and/or data input fields that are related to the selected category.

In some embodiments, the method also includes receiving, at the server and from the client via the rules builder interface, a location selection that specifies a custom geofenced zone as the first pre-defined geographic area. In one example, the method can also include creating, at the location infrastructure application and from the client, the custom geofenced zone on behalf of the client; and presenting the custom geofenced zone as a selectable option when the client is making the first user context selection. In some embodiments, the first pre-defined geographic area is a custom geofenced zone defined by one or more on-site beacons installed in the first pre-defined geographic area, and the first user context selection includes providing identifying information for the one or more on-site beacons. In different embodiments, the method can also include registering (or enrolling or entering unique beacon device identification/reference information), at the location infrastructure application on behalf of the client, the one or more on-site beacons; and presenting, via the rules builder interface and when the client is making the first user context selection, a list of selectable options, each selectable option corresponding to one registered on-site beacon.

In some embodiments, the method further includes receiving, at the server and from the client via the rules builder interface, a place of interest (POI) selection that specifies a first POI from multiple places of interest (POIs) that are identified in a POI database associated with the location infrastructure application, wherein the first pre-defined geographic area is the first POI. In one example, the first pre-defined geographic area is a region defined by one of a zip code, city, county, state, and country, and the first user context selection includes identification of the region. In another embodiment, the method includes receiving, at the server and from the client via the rules builder interface, a time period selection for the first rule, the time period selection defining a window during which the conditions for the trigger selection must occur.

Other methods can also be contemplated within the scope of this disclosure. For example, a method of building a geolocation-based context-aware rule is also disclosed. The method includes a first step of receiving, at a server for the location infrastructure application and from a client via a rules builder interface, a first selection specifying a first user context that includes detection of a first event involving a first user device occurring in or near a first pre-defined geographic area. A second step includes receiving, at the server and from the client via the rules builder interface, a second selection, the second selection including a first action to be implemented by the location infrastructure application upon detection that all conditions specified by the first user context are satisfied. In addition, the method includes a third step of generating, at the server, a first rule incorporating the first selection and the second selection, and a fourth step of storing, at the server, the first rule in a rules repository on behalf of the client. A fifth step includes monitoring, at the server over a first period of time, geolocation data of the first user device, and a sixth step includes determining, based on the geolocation data, that all conditions specified by the first user context have been satisfied. A seventh step includes causing the first action to be performed via a mobile application running on the first user device.

In other embodiments, the method may include additional steps or aspects. In some examples, the method includes an additional step of presenting, via the rules builder interface and when the client is making the second selection, a list of selectable options, each selectable option corresponding to one action type from a set of action types that include notifications, navigation, tracking, and user experience configurations for the mobile application.

In different embodiments, there are other systems that can also be contemplated within the scope of this disclosure. For example, a mobile telephone including a location infrastructure application configured to provide location information to a server, and receive responses from the server is also disclosed. The telephone can include a location determining module configured to generate location information related to a position of the mobile phone. In some embodiments, the mobile telephone sends the location information to a server. Furthermore, the mobile telephone can receive from the server instructions to perform at least one action based on the location information sent to the server, where the creation of the instructions includes receiving, at a server for the location infrastructure application and from a client via a rules builder interface, a first user context selection to serve as a trigger for a first rule, the first user context selection specifying a first user context that includes detection of a first event occurring in or near a first pre-defined geographic area; receiving, at the server and from the client via the rules builder interface, a response selection for the first rule, the response selection including at least a first action to be implemented by the location infrastructure application upon detection that all conditions specified by the first user context selection are satisfied; receiving, at the server and from a first user device (e.g., the mobile telephone), first location data for the first user device over a first period of time; verifying, at the server and based on the first location data, the first event occurred in or near the first pre-defined geographic area; and causing, by the server and in response to the verification, the first action to be performed (e.g., by the mobile telephone).

In other embodiments, the mobile telephone system may include additional features, components, or aspects. In some examples, a receipt of a signal causes the first action to be performed via the location infrastructure application running on the mobile telephone. In another example, the signal is received at a software development kit (SDK) associated with the location infrastructure application that is installed in a mobile application running on the mobile telephone (e.g., the first user device). In some embodiments, causing the first action to be performed includes modifying an account setting for a first user associated with the first user device (e.g., the mobile telephone). in different embodiments, the rules builder interface includes a graphical user interface (GUI) menu offering selectable options, each selectable option designating one of a set of pre-defined user context types from which the first user context selection was made. In another example, the pre-defined user context types include one or more of a geofence context type, a beacon context type, a trips context type, a regions context type, a place context type, and a fraud context type. In some embodiments, the server receives (from the client via the rules builder interface) a location selection that specifies a custom geofenced zone as the first pre-defined geographic area. In one example, the custom geofenced zone generated on behalf of the client is created at the location infrastructure application, and the location infrastructure application presents the custom geofenced zone as a selectable option when the client is making the first user context selection. In some embodiments, where the first pre-defined geographic area is a custom geofenced zone defined by one or more on-site beacons installed in the first pre-defined geographic area, and the first user context selection includes providing identifying information for the one or more on-site beacons. In different embodiments, the are one or more on-site beacons that have been registered at the location infrastructure application (on behalf of the client), and the rules builder interface presents a list of selectable options, each selectable option corresponding to one registered on-site beacon, when the client is making the first user context selection. In one example, creation of the instructions can also include receiving, at the server and from the client via the rules builder interface, a place of interest (POI) selection that specifies a first POI from multiple places of interest (POIs) that are identified in a POI database associated with the location infrastructure application, where the first pre-defined geographic area is the first POI. In some embodiments, the first pre-defined geographic area is a region defined by one of a zip code, city, county, state, and country, and the first user context selection includes identification of the region. In other examples, creation of the instructions can also include receiving, at the server and from the client via the rules builder interface, a time period selection for the first rule, the time period selection defining a window during which the conditions for the trigger selection must occur.

In different embodiments, there are other systems that can also be contemplated within the scope of this disclosure. For example, a mobile telephone including a location infrastructure application configured to provide location information to a server, and receive responses from the server is also disclosed. The telephone can include a location determining module configured to generate location information related to a position of the mobile phone. In some embodiments, the mobile telephone sends the location information to a server. Furthermore, the mobile telephone can receive from the server instructions to perform at least one action based on the location information sent to the server, where the creation of the instructions includes receiving, at the server for the location infrastructure application and from a client via a rules builder interface, a first selection specifying a first user context that includes detection of a first event involving a first user device occurring in or near a first pre-defined geographic area; receiving, at the server and from the client via the rules builder interface, a second selection, the second selection including a first action to be implemented by the location infrastructure application upon detection that all conditions specified by the first user context are satisfied; generating, at the server, a first rule incorporating the first selection and the second selection; and storing, at the server, the first rule in a rules repository on behalf of the client. The mobile telephone device can provide, to the server over a first period of time, geolocation data of the mobile telephone (e.g., first user device), and the server can then determine, based on the geolocation data, that all conditions specified by the first user context have been satisfied. Such a determination can cause the first action to be performed via a mobile application running on the mobile telephone device (first user device). In some embodiments, the creation of the instructions also includes presenting, via the rules builder interface and when the client is making the second selection, a list of selectable options, each selectable option corresponding to one action type from a set of action types that include notifications, navigation, tracking, and user experience configurations for the mobile application.

In different embodiments, the embodiments provide for a location infrastructure system that includes a mobile telephone. The mobile telephone includes a location infrastructure application configured to provide location information to a server associated with the location infrastructure application, receive responses and instructions from the server, and perform at least one action based on the instructions, and a location determining module configured to generate location information related to a position of the mobile telephone and send the location information to the server. The location infrastructure system also includes the server, comprising a processor and machine-readable media including instructions which, when executed by the processor, cause the processor to: (1) receive, at the server and from a client via a rules builder interface, a first user context selection to serve as a trigger for a first rule, the first user context selection specifying a first user context that includes detection of a first event occurring in or near a first pre-defined geographic area; (2) receive, at the server and from the client via the rules builder interface, a response selection for the first rule, the response selection including at least a first action to be implemented by the location infrastructure application upon detection that all conditions specified by the first user context selection are satisfied; (3) receive, at the server and from the mobile telephone, first location data for the mobile telephone over a first period of time; (4) verify, at the server and based on the first location data, the first event occurred in or near the first pre-defined geographic area; and (5) cause, by the server and in response to the verification, the first action to be performed.

In some embodiments, the instructions further cause the processor to transmit a signal to the mobile telephone that causes the first action to be performed via a mobile application running on the mobile telephone. In some other embodiments, the instructions further cause the processor to receive, at the server and from the client via the rules builder interface, a location selection that specifies a custom geofenced zone as the first pre-defined geographic area. In another example, the instructions further cause the processor to create, at the location infrastructure application and from the client, the custom geofenced zone on behalf of the client; and present the custom geofenced zone as a selectable option when the client is making the first user context selection. In some embodiments, the first pre-defined geographic area is a custom geofenced zone defined by one or more on-site beacons installed in the first pre-defined geographic area, and the first user context selection includes providing identifying information for the one or more on-site beacons.

As noted earlier, in different embodiments, the proposed mobile telephone system includes a mobile telephone device (e.g., user device) such as a mobile computing device, which includes or has access to (over a network) to a mobile application (“mobile app”) that receives instructions from the remote (server) location infrastructure application. Thus, mobile app can reside entirely on the user device, be accessed over a network via a remote server, or include some components on user device and others at the remote server. In different embodiments, such a network could include one or more Wide Area Networks (WANs), Wi-Fi networks, Bluetooth or other Personal Area Networks, cellular networks, as well as other kinds of networks. In addition, the mobile telephone device can include provisions for communicating with, and processing information from, a server as well as other devices. It may be appreciated that different devices could communicate using different networks and/or communication protocols. For purposes of this disclosure, a communication protocol refers broadly to any type of communication system that enables wireless communications to/from a mobile device. A communication module of the mobile telephone device may include a wireless connection that implements or includes components providing one or more communication protocols such as Bluetooth® radio technology, communication protocols described in IEEE 802.11 (including any IEEE 802.11 revisions) such as Wi-Fi, as well as communication protocols that rely on cellular technology (such as GSM, CDMA, UMTS, EV-DO, WiMAX, or LTE), or Zigbee® technology, among other possibilities. In many cases, the communication module is a wireless connection; however, wired connections may also be used. For example, the communication module may include a wired serial bus such as a universal serial bus or a parallel bus, among other connections. Each device may include a communication system such as a radio or other provisions for communicating using one or more communication methods. In particular, the communication system includes provisions for communicating with other nearby devices and/or a server over a network. For example, each communication system could include a Wi-Fi radio, a Bluetooth radio, and/or a cellular network radio.

Furthermore, the mobile telephone device may include one or more processors and memory. Memory may comprise a non-transitory computer readable medium. Instructions stored within memory may be executed by the one or more processors. In some embodiments, an end-user can interact with the proposed system, for example via the mobile app installed on their mobile telephone device. In some embodiments, some or all components and features of the mobile app 420 can be downloaded to be accessible locally on the device. In other embodiments, some or all components and features can be accessed via a web-based service over a network. The mobile app can offer a user settings and profile interface (“user interface”) for accessing and modifying settings and viewing application activity. The user interface may refer to an operating system user interface or the interface of one or more software applications that may run on the mobile telephone device. In some embodiments, user account data can be stored in the app or at the server, and include app-related user-specific information such as user preferences, such as but not limited to the user's consent/permission/authorization to specific actions that might be performed by the mobile app (e.g., what trigger events are not allowed to be detected or used to produce a reaction in their mobile telephone device, or what type of data can be collected at the mobile telephone device for use by the mobile app and client, as well as the user's alert preferences (e.g., SMS messages, in-app messages, audio alerts, volume, visual alerts, frequency of alerts, etc.) that can affect how the SDK presents or executes the server's instructions. In some embodiments, the mobile app can be configured to connect to the server (for example, via a Wi-Fi or cellular connection) to add or modify information for a user's account, for example in a cloud-hosted user account database. In other embodiments, such data can be stored locally. In other embodiments, the mobile app can refer to the remote service features and components that are being accessed by the mobile telephone device over a network.

As noted earlier, in different embodiments, the mobile telephone device can be used to monitor a user's individual actions, locations, movement, or other device activity or in-app activity. In different embodiments, the mobile telephone device can include or otherwise be in communication with one or more sensor devices (“sensors”) that may be used to determine the user's current location. Some non-limiting examples of such sensors include, but are not limited to, image sensors (cameras), accelerometers, microphone or other audio sensors, capacitive sensors, motion sensors, heat sensors, location data, infrared (IR) sensors, time-of-flight (TOF) sensors, GPS, and/or ultrasonic sensors. In some embodiments, the mobile app is configured to receive location data from a GPS of user device to determine the current location and heading for user. Still other sensors that can collect data for use by the location infrastructure application and rules builder interface include (a) Smoke, Gas and Alcohol (and/or other chemicals) sensors; (b) Temperature sensors; (c) Pressure sensors; (d) Cameras and other image and/or light sensors; (e) UV light sensors; (f) Moisture/Humidity sensors; (g) Electrostatic sensors; (h) Audio sensors and other sound/volume sensors (e.g., microphones); (i) Motion/speed sensors; (l) Wind Speed sensors; (m) Proximity sensors; (n) Infrared and Heat sensors; (o) occupancy sensors; (p) pathogen sensors (e.g., devices that apply swab chemistry for effective sanitation and allergen control, pasteurization verification, and pesticide, for example using a luminometer); and/or (q) IoT network devices. In addition, in still other embodiments, sensors can include ultrasonic sensors, touch sensors, aerosol characterization sensors, magnetometers, color sensors, tilt sensors, and flow and level sensors. Thus, in different embodiments, sensors may collect data regarding location, wind, heat/cold, congestion, temperature of occupants, proximity of occupants, surface areas, etc. around the building.

In different embodiments, data collected by the mobile telephone device sensors can be received by a sensor data processor for managing, storing, and processing the received sensor data. The data is used to determine whether the required conditions have been met for a particular trigger condition that would cause implementation of a rule as created by the client at the rules builder interface. Furthermore, “sensors” can be partially or entirely virtual. A sensor, as used herein, does not have to be a physical device, but rather a “sensor” output could be a value provided by another cloud service or API. For example, a “sensor” could output the current weather forecast for a mobile telephone device's location from NOAA or other localized data from an external (third-party) database/information service.

In some embodiments, the sensor data processor may reside on a server computer system configured to provide access to sensor data from the mobile telephone device. The server computer system may comprise any type of computer system, including any combination of hardware and/or software that is configured to provide access to sensor data from devices located within particular physical spaces. A server computer system may include various engines, functional blocks, and components that may be implemented on a single computer system, or may be implemented as a distributed computer system that includes elements resident in a cloud environment, and/or that implement aspects of cloud computing (i.e., at least one of the various illustrated engines may be implemented locally, while at least one other engine may be implemented remotely). In addition, the various engines, functional blocks, and/or components of the server computer system may be implemented as software, hardware, or a combination of software and hardware. Although not illustrated, the various engines of the server computer system may access and/or utilize a processor and memory, such as processors and the memory, as needed, to perform their various functions.

It is appreciated that methods in accordance with the present disclosure can include any combination of the aspects and features described herein. That is, methods and systems in accordance with the present disclosure are not limited to the combinations of aspects and features specifically described herein, but also include any combination of the aspects and features provided.

In some embodiments (not shown in the drawings), the interface can include a welcome or header message(s), and/or a plurality of data input fields can also be presented. Some non-limiting examples of such fields can include options directed to identification of the account owner and other users (e.g., name, phone number, address). In addition, the interface can provide a plurality of selectable options, such as navigation options (e.g., “Back”, “Save”, “Next”), or additional menu options for accessing other features or aspects of the profile. As a general matter, it should be understood that the text and specific wording shown in the figures are for purposes of illustration only and in no way limit the manner by which the application may communicate or receive information. In addition, in other embodiments, one or more options or other fields and text may appear differently and/or may be displayed or generated anywhere else on the screen(s) associated with the user's system, including spaced apart from, adjacent to, or around the user interface. In other words, the figures present only one possible layout of the interface, and do not in any way limit the presentation arrangement of any of the disclosed features.

The processes and methods of the embodiments described in this detailed description and shown in the figures can be implemented using any kind of computing system having one or more central processing units (CPUs) and/or graphics processing units (GPUs). The processes and methods of the embodiments could also be implemented using special purpose circuitry such as an application specific integrated circuit (ASIC). The processes and methods of the embodiments may also be implemented on computing systems including read only memory (ROM) and/or random-access memory (RAM), which may be connected to one or more processing units. Examples of computing systems and devices include, but are not limited to: servers, cellular phones, smart phones, tablet computers, notebook computers, e-book readers, laptop or desktop computers, all-in-one computers, as well as various kinds of digital media players.

The processes and methods of the embodiments can be stored as instructions and/or data on non-transitory computer-readable media. The non-transitory computer readable medium may include any suitable computer readable medium, such as a memory, such as RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, magnetic disks or tapes, a read-only memory (ROM), a random access memory (RAM), a static random access memory (SRAM), a portable compact disc read-only memory (CD-ROM), an erasable programmable read-only memory (EPROM or Flash memory), electrically erasable programmable read-only memories (EEPROM), a digital versatile disk (DVD and DVD-ROM), a memory stick, other kinds of solid state drives, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

The embodiments may utilize any kind of network for communication between separate computing systems. A network can comprise any combination of local area networks (LANs) and/or wide area networks (WANs), using both wired and wireless communication systems. A network may use various known communications technologies and/or protocols. Communication technologies can include, but are not limited to: Ethernet, 802.11, worldwide interoperability for microwave access (WiMAX), mobile broadband (such as CDMA, and LTE), digital subscriber line (DSL), cable internet access, satellite broadband, wireless ISP, fiber optic internet, as well as other wired and wireless technologies. Networking protocols used on a network may include transmission control protocol/Internet protocol (TCP/IP), multiprotocol label switching (MPLS), User Datagram Protocol (UDP), hypertext transport protocol (HTTP), hypertext transport protocol secure (HTTPS) and file transfer protocol (FTP) as well as other protocols.

Data exchanged over a network may be represented using technologies and/or formats including hypertext markup language (HTML), extensible markup language (XML), Atom, JavaScript Object Notation (JSON), YAML, as well as other data exchange formats. In addition, information transferred over a network can be encrypted using conventional encryption technologies such as secure sockets layer (SSL), transport layer security (TLS), and Internet Protocol security (Ipsec).

The computing devices and systems described herein may include one or more processors, a memory, one or more storage devices, and one or more input/output (I/O) devices controllable via one or more I/O interfaces. The various components may be interconnected via at least one system bus, which may enable the transfer of data between the various modules and components of the system.

The processor(s) may be configured to process instructions for execution within the system. The processor(s) may include single-threaded processor(s), multi-threaded processor(s), or both. The processor(s) may be configured to process instructions stored in the memory or on the storage device(s). The processor(s) may include hardware-based processor(s) each including one or more cores. The processor(s) may include general purpose processor(s), special purpose processor(s), or both. The memory may store information within the system. In some implementations, the memory includes one or more computer-readable media. The memory may include any number of volatile memory units, any number of non-volatile memory units, or both volatile and non-volatile memory units. The memory may include read-only memory, random access memory, or both. In some examples, the memory may be employed as active or physical memory by one or more executing software modules.

The storage device(s) may be configured to provide (e.g., persistent) mass storage for the system. In some implementations, the storage device(s) may include one or more computer-readable media. For example, the storage device(s) may include a floppy disk device, a hard disk device, an optical disk device, or a tape device. The storage device(s) may include read-only memory, random access memory, or both. The storage device(s) may include one or more of an internal hard drive, an external hard drive, or a removable drive.

One or both of the memory or the storage device(s) may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system. In some implementations, the CRSM may include a data store that provides storage of computer-readable instructions or other information in a non-transitory format. The CRSM may be incorporated into the system or may be external with respect to the system. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) and the memory may be supplemented by, or incorporated into, one or more application-specific integrated circuits (ASICs).

The system may include one or more I/O devices. The I/O device(s) may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system, or may be external with respect to one or more computing devices of the system.

The system may include one or more I/O interfaces to enable components or modules of the system to control, interface with, or otherwise communicate with the I/O device(s). The I/O interface(s) may enable information to be transferred in or out of the system, or between components of the system, through serial communication, parallel communication, or other types of communication. For example, the I/O interface(s) may comply with a version of the RS-232 standard for serial ports, or with a version of the IEEE 1284 standard for parallel ports. As another example, the I/O interface(s) may be configured to provide a connection over Universal Serial Bus (USB) or Ethernet. In some examples, the I/O interface(s) may be configured to provide a serial connection that is compliant with a version of the IEEE 1394 standard. The I/O interface(s) may also include one or more network interfaces that enable communications between computing devices in the system, or between the system and other network-connected computing systems. The network interface(s) may include one or more network interface controllers (NICs) or other types of transceiver devices configured to send and receive communications over one or more networks, such as the network(s), using any network protocol.

Computing devices of the system may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANS (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back-end component, e.g., as a data server, or that includes a middleware component, e.g., an application server, or that includes a front end component, e.g., a client computer having a graphical user interface or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet. The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A mobile telephone including a location infrastructure application configured to provide location information to a server, and receive responses from the server, the mobile telephone comprising:
a location determining module configured to generate location information related to a position of the mobile telephone;
the mobile telephone sending the location information to a server;
the mobile telephone receiving from the server instructions to perform at least one action based on the location information sent to the server; and
wherein the creation of the instructions includes:
receiving, at a server for the location infrastructure application and from a client via a rules builder interface, a first user context selection to serve as a trigger for a first rule, the first user context selection specifying a first user context that includes detection of a first event occurring in or near a first pre-defined geographic area;
receiving, at the server and from the client via the rules builder interface, a response selection for the first rule, the response selection including at least a first action to be implemented by the location infrastructure application upon detection that all conditions specified by the first user context selection are satisfied;
receiving, at the server and from the mobile telephone, first location data for the mobile telephone over a first period of time;
verifying, at the server and based on the first location data, the first event occurred in or near the first pre-defined geographic area; and
causing, by the server and in response to the verification, the first action to be performed.

2. The mobile telephone of claim 1, wherein a receipt of a signal causes the first action to be performed via the location infrastructure application running on the mobile telephone.

3. The mobile telephone of claim 2, wherein the signal is received by a software development kit (SDK) associated with the location infrastructure application running on the mobile telephone.

4. The mobile telephone of claim 1, wherein the first action to be performed includes modifying an account setting for a first user associated with the location infrastructure application running on the mobile telephone.

5. The mobile telephone of claim 1, wherein the rules builder interface includes a graphical user interface (GUI) menu offering selectable options, each selectable option designating one of a set of pre-defined user context types from which the first user context selection was made.

6. The mobile telephone of claim 5, wherein the pre-defined user context types include one or more of a geofence context type, a beacon context type, a trips context type, a regions context type, a place context type, and a fraud context type.

7. The mobile telephone of claim 1, wherein the creation of the instructions further includes receiving, at the server and from the client via the rules builder interface, a location selection that specifies a custom geofenced zone as the first pre-defined geographic area.

8. The mobile telephone of claim 7, wherein the creation of the instructions further includes:
creating, at the location infrastructure application and from the client, the custom geofenced zone on behalf of the client; and
presenting the custom geofenced zone as a selectable option when the client is making the first user context selection.

9. The mobile telephone of claim 1, wherein the first pre-defined geographic area is a custom geofenced zone defined by one or more on-site beacons installed in the first pre-defined geographic area, and the first user context selection includes providing identifying information for the one or more on-site beacons.

10. The mobile telephone of claim 9, wherein the creation of the instructions further includes:
registering, at the location infrastructure application on behalf of the client, the one or more on-site beacons; and
presenting, via the rules builder interface and when the client is making the first user context selection, a list of selectable options, each selectable option corresponding to one registered on-site beacon.

11. The mobile telephone of claim 1, wherein the creation of the instructions further includes receiving, at the server and from the client via the rules builder interface, a place of interest (POI) selection that specifies a first POI from multiple places of interest (POIs) that are identified in a POI database associated with the location infrastructure application, and the first pre-defined geographic area is the first POI.

12. The mobile telephone of claim 1, wherein the first pre-defined geographic area is a region defined by one of a zip code, city, county, state, and country, and the first user context selection includes identification of the region.

13. The mobile telephone of claim 1, wherein the creation of the instructions further includes receiving, at the server and from the client via the rules builder interface, a time period selection for the first rule, the time period selection defining a window during which the conditions for the trigger selection must occur.

14. A mobile telephone including a location infrastructure application configured to provide location information to a server, and receive responses from the server, the mobile telephone comprising:
a location determining module configured to generate location information related to a position of the mobile telephone;
the mobile telephone sending the location information to a server;
the mobile telephone receiving from the server instructions to perform at least one action based on the location information sent to the server; and
wherein the creation of the instructions includes:
receiving, at a server for the location infrastructure application and from a client via a rules builder interface, a first selection specifying a first user context that includes detection of a first event involving a mobile telephone occurring in or near a first pre-defined geographic area;
receiving, at the server and from the client via the rules builder interface, a second selection, the second selection including a first action to be implemented by the location infrastructure application upon detection that all conditions specified by the first user context are satisfied;
generating, at the server, a first rule incorporating the first selection and the second selection;
storing, at the server, the first rule in a rules repository on behalf of the client;
monitoring, at the server over a first period of time, geolocation data of the mobile telephone;
determining, based on the geolocation data, that all conditions specified by the first user context have been satisfied; and
causing the first action to be performed via a mobile application running on the mobile telephone.

15. The mobile telephone of claim 14, wherein the creation of the instructions further includes presenting, via the rules builder interface and when the client is making the second selection, a list of selectable options, each selectable option corresponding to one action type from a set of action types that include notifications, navigation, tracking, and user experience configurations for the mobile application.

16. A location infrastructure system, the system including:
a mobile telephone including:
a location infrastructure application configured to provide location information to a server associated with the location infrastructure application, receive responses and instructions from the server, and perform at least one action based on the instructions,
a location determining module configured to generate location information related to a position of the mobile telephone and send the location information to the server; and
the server, comprising a processor and machine-readable media including instructions which, when executed by the processor, cause the processor to:
receive, at the server and from a client via a rules builder interface, a first user context selection to serve as a trigger for a first rule, the first user context selection specifying a first user context that includes detection of a first event occurring in or near a first pre-defined geographic area;
receive, at the server and from the client via the rules builder interface, a response selection for the first rule, the response selection including at least a first action to be implemented by the location infrastructure application upon detection that all conditions specified by the first user context selection are satisfied;
receive, at the server and from the mobile telephone, first location data for the mobile telephone over a first period of time;
verify, at the server and based on the first location data, the first event occurred in or near the first pre-defined geographic area; and
cause, by the server and in response to the verification, the first action to be performed.

17. The system of claim 16, wherein the instructions further cause the processor to transmit a signal to the mobile telephone that causes the first action to be performed via a mobile application running on the mobile telephone.

18. The system of claim 16, wherein the instructions further cause the processor to receive, at the server and from the client via the rules builder interface, a location selection that specifies a custom geofenced zone as the first pre-defined geographic area.

19. The system of claim 18, wherein the instructions further cause the processor to:
create, at the location infrastructure application and from the client, the custom geofenced zone on behalf of the client; and
present the custom geofenced zone as a selectable option when the client is making the first user context selection.

20. The system of claim 16, wherein the first pre-defined geographic area is a custom geofenced zone defined by one or more on-site beacons installed in the first pre-defined geographic area, and the first user context selection includes providing identifying information for the one or more on-site beacons.
